(19) United States
(12) Patent Application Publication
(10) Pub. No.: US 2026/0213783 A1
(43) Pub. Date: Jul. 23, 2026

(54) FREQUENCY HOPPING FOR AMBIENT INTERNET OF THINGS READER-TO-DEVICE REPETITIONS

(71) Applicant: QUALCOMM Incorporated, San Diego, CA (US)

(72) Inventors: Ahmed Abdelaziz Ibrahim Abdelaziz ZEWAIL, San Diego, CA (US); Piyush GUPTA, Bridgewater, NJ (US)

(21) Appl. No.: 19/028,999

(22) Filed: Jan. 17, 2025

(51) Int. Cl. H04B 1/7143; H04L 1/08

(52) U.S. Cl. CPC H04B 1/7143; H04L 1/08

(57) ABSTRACT

Various aspects of the present disclosure generally relate to wireless communication. In some aspects, an ambient internet of things (A-IoT) reader device may receive configuration information that indicates a frequency hopping pattern for a reader-to-device (R2D) signal. The A-IoT reader device may transmit the R2D signal and one or more repetitions of a data block of the R2D signal on different carrier frequencies in accordance with the frequency hopping pattern. Numerous other aspects are described.

### INTRODUCTION

Aspects of the present disclosure generally relate to wireless communication and specifically relate to techniques, apparatuses, and methods associated with ambient internet of things (A-IoT) communications.

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to an apparatus for wireless communication at an ambient internet of things (A-IoT) reader device. The apparatus may include one or more memories and one or more processors coupled with the one or more memories. The one or more processors may be configured to cause the A-IoT reader device to receive configuration information that indicates a frequency hopping pattern for a reader-to-device (R2D) signal. The one or more processors may be configured to cause the A-IoT reader device to transmit the R2D signal and one or more repetitions of a data block of the R2D signal on different carrier frequencies in accordance with the frequency hopping pattern.

Some aspects described herein relate to an apparatus for wireless communication at an A-IoT device. The apparatus may include one or more memories and one or more processors coupled with the one or more memories. The one or more processors may be configured to cause the A-IoT device to receive, from an A-IoT reader device, an R2D signal and one or more repetitions of a data block of the R2D signal on different carrier frequencies. The one or more processors may be configured to cause the A-IoT device to decode the data block of the R2D signal based on at least one of the R2D signal or the one or more repetitions.

Some aspects described herein relate to an apparatus for wireless communication at a network device. The apparatus may include one or more memories and one or more processors coupled with the one or more memories. The one or more processors may be configured to cause the network device to receive, from an A-IoT reader device, capability information that indicates a frequency hopping capability of the A-IoT reader device. The one or more processors may be configured to cause the network device to transmit, to the A-IoT reader device, configuration information that indicates a frequency hopping pattern for an R2D signal and one or more repetitions of a data block of the R2D signal.

Some aspects described herein relate to a method of wireless communication at an A-IoT reader device. The method may include receiving configuration information that indicates a frequency hopping pattern for an R2D signal. The method may include transmitting the R2D signal and one or more repetitions of a data block of the R2D signal on different carrier frequencies in accordance with the frequency hopping pattern.

Some aspects described herein relate to a method of wireless communication at an A-IoT device. The method may include receiving, from an A-IoT reader device, an R2D signal and one or more repetitions of a data block of the R2D signal on different carrier frequencies. The method may include decoding the data block of the R2D signal based on at least one of the R2D signal or the one or more repetitions.

Some aspects described herein relate to a method of wireless communication at a network device. The method may include receiving, from an A-IoT reader device, capability information that indicates a frequency hopping capability of the A-IoT reader device. The method may include transmitting, to the A-IoT reader device, configuration information that indicates a frequency hopping pattern for an R2D signal and one or more repetitions of a data block of the R2D signal.

Some aspects described herein relate to a non-transitory computer-readable medium that stores a set of instructions for wireless communication by A-IoT reader device. The set of instructions, when executed by one or more processors of the A-IoT reader device, may cause the A-IoT reader device to receive configuration information that indicates a frequency hopping pattern for an R2D signal. The set of instructions, when executed by one or more processors of the A-IoT reader device, may cause the A-IoT reader device to transmit the R2D signal and one or more repetitions of a data block of the R2D signal on different carrier frequencies in accordance with the frequency hopping pattern.

Some aspects described herein relate to a non-transitory computer-readable medium that stores a set of instructions for wireless communication by an A-IoT device. The set of instructions, when executed by one or more processors of the A-IoT device, may cause the A-IoT device to receive, from an A-IoT reader device, an R2D signal and one or more repetitions of a data block of the R2D signal on different carrier frequencies. The set of instructions, when executed by one or more processors of the A-IoT device, may cause the A-IoT device to decode the data block of the R2D signal based on at least one of the R2D signal or the one or more repetitions.

Some aspects described herein relate to a non-transitory computer-readable medium that stores a set of instructions for wireless communication by a network device. The set of instructions, when executed by one or more processors of the network device, may cause the network device to receive, from an A-IoT reader device, capability information that indicates a frequency hopping capability of the A-IoT reader device. The set of instructions, when executed by one or more processors of the network device, may cause the network device to transmit, to the A-IoT reader device, configuration information that indicates a frequency hopping pattern for an R2D signal and one or more repetitions of a data block of the R2D signal.

Some aspects described herein relate to an apparatus for wireless communication. The apparatus may include means for receiving configuration information that indicates a frequency hopping pattern for an R2D signal. The apparatus may include means for transmitting the R2D signal and one or more repetitions of a data block of the R2D signal on different carrier frequencies in accordance with the frequency hopping pattern.

Some aspects described herein relate to an apparatus for wireless communication. The apparatus may include means for receiving, from an A-IoT reader device, an R2D signal and one or more repetitions of a data block of the R2D signal on different carrier frequencies. The apparatus may include means for decoding the data block of the R2D signal based on at least one of the R2D signal or the one or more repetitions.

Some aspects described herein relate to an apparatus for wireless communication. The apparatus may include means for receiving, from an A-IoT reader device, capability information that indicates a frequency hopping capability of the A-IoT reader device. The apparatus may include means for transmitting, to the A-IoT reader device, configuration information that indicates a frequency hopping pattern for an R2D signal and one or more repetitions of a data block of the R2D signal.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIGS. 3A-3C are diagrams illustrating examples associated with different types of ambient internet of thing (A-IoT) devices, in accordance with the present disclosure.

FIGS. 4A-4D are diagrams illustrating an example associated with backscatter communications, in accordance with the present disclosure.

FIGS. 5A-5D are diagrams illustrating examples of topologies for A-IoT devices, in accordance with the present disclosure.

FIG. 6 is a diagram illustrating an example of interference in an A-IoT system, in accordance with the present disclosure.

FIGS. 7A-7D are diagrams illustrating examples associated with frequency hopping for A-IoT reader-to-device (R2D) repetitions, in accordance with the present disclosure.

FIG. 8 is a diagram illustrating an example process performed, for example, at an A-IoT reader device or an apparatus of an A-IoT reader device, in accordance with the present disclosure.

FIG. 9 is a diagram illustrating an example process performed, for example, at an A-IoT device or an apparatus of an A-IoT device, in accordance with the present disclosure.

FIG. 10 is a diagram illustrating an example process performed, for example, at a network device or an apparatus of a network device, in accordance with the present disclosure.

FIG. 11 is a diagram of an example apparatus for wireless communication, in accordance with the present disclosure.

FIG. 12 is a diagram illustrating an example of a hardware implementation for an apparatus employing a processing system, in accordance with the present disclosure.

FIG. 13 is a diagram illustrating an example of an implementation of code and circuitry for an apparatus, in accordance with the present disclosure.

FIG. 14 is a diagram of an example apparatus for wireless communication, in accordance with the present disclosure.

FIG. 15 is a diagram illustrating an example of a hardware implementation for an apparatus employing a processing system, in accordance with the present disclosure.

FIG. 16 is a diagram illustrating an example of an implementation of code and circuitry for an apparatus, in accordance with the present disclosure.

FIG. 17 is a diagram of an example apparatus for wireless communication, in accordance with the present disclosure.

FIG. 18 is a diagram illustrating an example of a hardware implementation for an apparatus employing a processing system, in accordance with the present disclosure.

FIG. 19 is a diagram illustrating an example of an implementation of code and circuitry for an apparatus, in accordance with the present disclosure.

### DETAILED DESCRIPTION

In some examples, a wireless communications device (e.g., a user equipment (UE) or other wireless communication device) may be an Internet of Things (IoT) device. Some IoT devices, such as ambient IoT (A-IoT) devices, may be associated with a relatively simple hardware design that may be designed to use low power and be implementable at low cost. A-IoT technology may include passive IoT (such as New Radio (NR) passive IoT for 5G Advanced), semi-passive IoT, active IoT, or ultra-light IoT. In passive IoT, a terminal (such as a tag or a similar device) may not include a battery or other long-term energy storage, and the terminal may accumulate energy from radio signaling. In some examples, the terminal may accumulate solar or other energy to supplement accumulated energy from radio signaling. To achieve further cost reduction and zero-power communication, backscattering communication may be implemented at a type of passive (or semi-passive) IoT device referred to as an “ambient backscatter device” or a “backscatter device,” which may modulate by reflecting radio signals from a radio frequency (RF) source to convey data. For example, a passive IoT device may reflect a radio wave that is radiated onto the passive IoT device and modulate the reflected radio wave to convey the data. Some IoT devices may be referred to as semi-passive IoT devices. At a semi-passive IoT device, communication between a reader and the IoT device does not need to be preceded by an energy harvesting waveform. For example, a semi-passive IoT device may include a battery or similar energy source that can power the semi-passive IoT device. Some IoT devices may be referred to as active IoT devices. An active IoT device may have a battery or similar energy source and an active radio, allowing for active transmission and reception without energy harvesting or backscattering. A-IoT technology may be useful in connection with industrial sensors, for which battery replacement may be prohibitively difficult or undesirable (such as for safety monitoring or fault detection in smart factories, infrastructures, or environments). Additionally, features of A-IoT devices, such as low cost, small size, simple or infrequent maintenance, durability, and long lifespan, may facilitate smart logistics and warehousing (for example, in connection with automated asset management). Furthermore, A-IoT technology may be useful in connection with smart home networks for household item management, wearable devices, or similar applications. In some examples, an A-IoT device may communicate with a reader (for example, a UE, a network node, or a network entity) by modulating or reflecting a radio signal from an RF source (for example, the reader, a network node, a UE, or another network entity).

In some examples, an A-IoT system may be deployed with multiple A-IoT reader devices (also referred to as “readers”). An A-IoT reader device (e.g., a reader) is a device that communicates with (e.g., transmits a signal to and/or receives a signal from) one or more A-IoT devices. For example, an A-IoT reader device (or reader) may be a network node, a UE, an intermediate node, and/or an assisting node, among other examples. In some examples, an A-IoT system deployed with multiple readers may include one or more stationary readers that are fixed at certain locations and/or one or more mobile readers having the capability to move to different locations. The A-IoT system may include one or more A-IoT devices. The readers and the one or more A-IoT devices may be physically dispersed throughout the A-IoT system.

In some examples, the A-IoT system may include a network commander. The network commander may be configured to support the A-IoT system. The network commander may be a central control unit (e.g., a controller) configured to manage the A-IoT system. For example, the network commander may be a reader controller configured to manage, configure, and/or otherwise support the readers in the A-IoT system. In some examples, the network commander may schedule and coordinate communications of all of the readers and/or collect data received (e.g., from one or more A-IoT devices) by the readers. In some examples, the network commander may be, or may be included in, a network node. In some other examples, the network commander may be, or may be included in, a UE. The network commander may also be referred to as a network commander device, a controller, a controller device, a central control unit, a network entity, a network node, a UE, a reader controller, or a wireless communication device, among other examples.

In some examples, the readers may operate in different modes to perform different actions for communicating with the one or more A-IoT devices, depending on scheduling decisions by the network commander. For example, a reader may transmit an energy harvesting (EH) signal to provide energy to an A-IoT device, transmit a reader-to-device (R2D) command to an A-IoT device, transmit a carrier wave (CW) signal to an A-IoT device, and/or receive a device-to-reader (D2R) response transmitted by an A-IoT device. The A-IoT device may transmit the D2R response by reflecting a signal received via a forward link (e.g., the CW signal) as a backscatter signal. An EH signal (or energizing signal) is an RF signal (e.g., an RF waveform) from which energy can be accumulated (e.g., harvested) by an IoT device (e.g., an A-IoT device having a capability to perform energy harvesting) to power or help to power the IoT device. A CW signal is an RF signal with a periodic waveform that can be modulated or reflected (e.g. by an A-IoT device) to convey or communicate information. The CW signal may be a continuous wave signal, such as a waveform with a fixed amplitude and/or frequency that can be modulated in amplitude, frequency, or phase to convey or communication information. In some examples, the CW signal may be a waveform that carries no information until the CW signal is modulated or reflected. In some examples, a CW signal may be backscattered by an A-IoT device. “Backscattering” refers to reflecting the CW signal to modulate the CW signal and thereby encode data or information on the resulting backscatter signal. Additionally, or alternatively, in some examples, a CW signal may be used for energy harvesting (e.g., the EH signal may be a CW signal) to provide energy to one or more A-IoT devices. An R2D command may include one or more signals transmitted from a reader to an A-IoT device via a forward link. The R2D command may also be referred to as an R2D signal or an R2D message. A D2R response may include one or more signals transmitted (e.g., reflected) from an A-IoT device to a reader via a backscatter link. The D2R response may be, or may include, a response to the R2D command. The D2R response may also be referred to as a D2R signal or a D2R message.

In some examples, a local clock error of an A-IoT device may adversely affect synchronization between the A-IoT device and a reader transmitting an R2D command, which may result in unsuccessful decoding of the R2D command at the A-IoT device. In some examples, block-level repetition may be performed for the R2D command. “Block-level repetition” of the R2D command refers to a reader (or multiple readers) repeatedly transmitting a data block (e.g., a transport block (TB)) of the R2D command multiple times consecutively. Such transmission of multiple consecutive repetitions of the TB of the R2D command may provide time diversity gain and increase the probability that at least one of the repetitions can be successfully decoded by the A-IoT device. However, the repetitions of the R2D command may experience multipath fading. Multipath fading refers to fluctuations in the magnitude, phase, and/or angle or arrival of a signal due to varying signal attenuation on different paths. Such multipath fading may cause errors in decoding the R2D command at the A-IoT device, even when block-level repetition is used. Such decoding errors may result in decreased reliability, increased latency, and decreased throughput for communications in an A-IoT system.

Various aspects relate generally to A-IoT communications. Some aspects more specifically relate to frequency hopping for A-IoT R2D repetitions. In some aspects, a network device (e.g., a network commander) may transmit, to an A-IoT reader device (e.g., a reader) configuration information. The configuration information may indicate a frequency hopping pattern for block-level repetition of an R2D signal. The A-IoT reader device may receive the configuration information, and the A-IoT reader device may transmit the R2D signal and one or more repetitions of at least a data block of the R2D signal on different carrier frequencies in accordance with the frequency hopping pattern. An A-IoT device may receive the R2D signal and one or more of the repetitions, and the A-IoT device may decode the data block of the R2D signal based on the R2D signal and/or the one or more of the repetitions. In some aspects, each repetition may include one or more automatic gain control (AGC) signals. In some aspects, the A-IoT reader device may transmit, to the network device, capability information that indicates a frequency hopping capability of the A-IoT reader device, and the configuration information may indicate time resources for transmission of the R2D signal and the one or more repetitions based at least in part on the capability information. In some examples, the time resource may include a time gap preceding each repetition of the one or more repetitions.

In some examples, by the A-IoT reader device transmitting the R2D signal and the one or more repetitions of the R2D signal on different frequencies in accordance with the frequency hopping pattern, the impact of multipath fading on the decoding of the data block of the R2D signal may be reduced. As a result, the R2D decoding performance (e.g., the accuracy and reliability of the R2D decoding) may be improved resulting in increased reliability, decreased latency, and increased throughput for communications in the A-IoT system. In some examples, by including one or more AGC symbols in each repetition of the data block of the R2D symbol, the A-IoT device may be enabled to perform AGC for each repetition received by the A-IoT device on a different carrier frequency. As a result, the R2D decoding performance at the A-IoT device may be further improved and interference on different carrier frequencies may be reduced, particularly in examples in which the antenna gain of a receiver of the A-IoT device is not flat for different frequencies. In some examples, by configuring the time resources for transmission of the R2D signal and the one or more repetitions with a time gap preceding each repetition, an A-IoT reader device may be provided with sufficient time to tune to a different carrier frequency for each repetition.

In some aspects, a dedicated phase for channel estimation may be configured. For example, a channel estimation phase may be configured subsequent to the energizing and R2D command transmission phase and prior to the CW signal transmission and D2R reception phase. The channel estimation phase is a time duration in which the pilot signal is transmitted and the channel estimation is performed. In some examples, the first A-IoT reader device may transmit the pilot signal during the channel estimation phase. In such examples, the second A-IoT reader device may receive the pilot signal and perform the channel estimation based at least in part on the pilot signal during the channel estimation phase. In some examples, by the second A-IoT reader receiving the pilot signal and performing the channel estimation in the channel estimation phase that is scheduled between the energizing and R2D command transmission phase and the CW signal transmission and D2R reception phase, an amount of time between performing the channel estimation and transmitting the CW signal with the interference nulling may be reduced (or minimized), which may result in increased accuracy of the interference nulling and a further decrease in interference from the transmission of the CW signal on the reception of the D2R response by the first A-IoT reader.

In some other aspects, the transmission of the pilot signal and the channel estimation based at least in part on the pilot signal may be scheduled as part of the energizing and R2D command transmission phase. In some examples, the first A-IoT reader device may simultaneously transmit the pilot signal and an EH signal during the energizing and R2D command transmission phase. As used herein, “simultaneously” may mean at least partially overlapping in the time domain. In some examples, the second A-IoT reader device may receive the pilot signal and perform the channel estimation during the energizing and R2D command transmission phase. For example, the second A-IoT reader device may receive the pilot signal either simultaneously with transmitting an EH signal during the energizing and R2D command transmission phase (e.g., in connection with the second A-IoT reader device having full-duplex capability), or the second A-IoT reader device may receive the pilot signal without transmitting an EH signal in a portion of the energizing and R2D command transmission phase (e.g., in connection with the second A-IoT reader device having a half-duplex capability). In some examples, by the second A-IoT reader device receiving the pilot signal and performing the channel estimation during the energizing and R2D command transmission phase, latency of the bistatic communications with the A-IoT device may be reduced, as compared with performing the channel estimation in a dedicated channel estimation phase.

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G NR is part of a continuous mobile broadband evolution promulgated by the Third Generation Partnership Project (3GPP). 5G NR may support enhanced mobile broadband (eMBB) access, IoT networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, RF sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

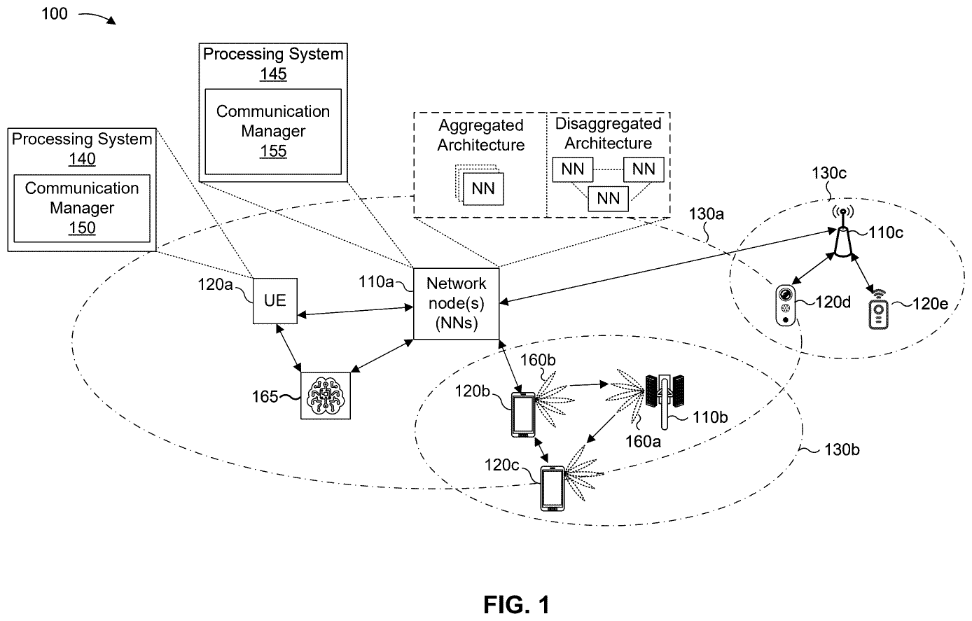

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a, a network node 110b, and a network node 110c. The network nodes 110 may support communications with multiple UEs 120. For example, in FIG. 1, the network nodes 110 support communication with a UE 120a, a UE 120b, a UE 120c, a UE 120d, and a UE 120e. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

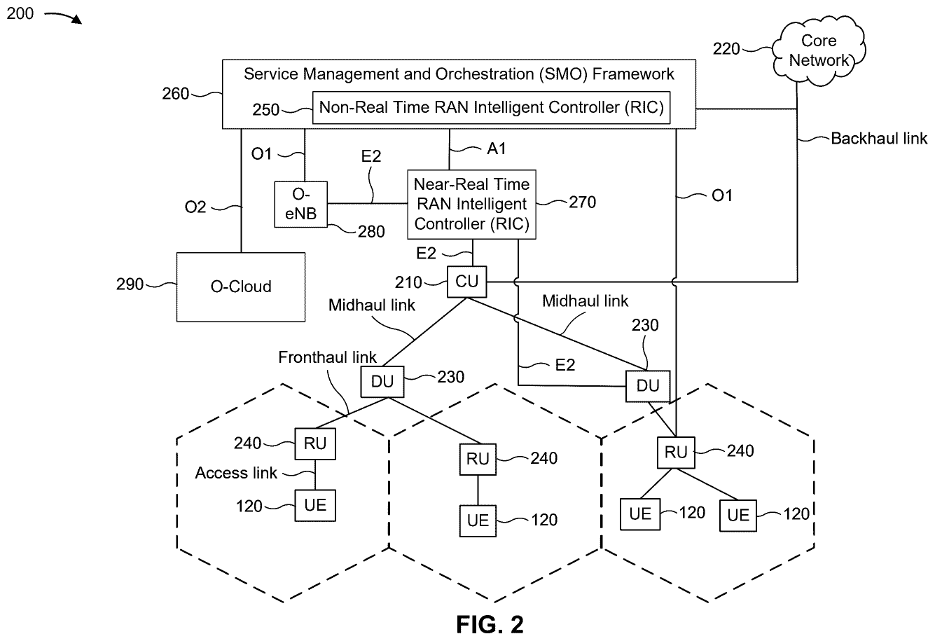

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a, a cell 130b, and a cell 130c), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

Some UEs 120 may be considered machine-type communication (MTC) UEs, evolved or enhanced machine-type communication (eMTC) UEs, further enhanced eMTC (feMTC) UEs, or enhanced feMTC (efeMTC) UEs, or further evolutions thereof, all of which may be simply referred to as “MTC UEs.” For example, the UE 120d and/or the UE 120e may be an MTC UE. An MTC UE may be, may include, or may be included in or coupled with a robot, an uncrewed aerial vehicle, a remote device, a sensor, a meter, a monitor, and/or a location tag. Some UEs 120 may be considered IoT devices. Some such UEs 120 may be implemented as NB-IoT (narrowband IoT) devices, such as the UE 120d and/or the UE 120e An IoT or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment (CPEs), which may include telecommunications devices that are installed at a customer location (such as a home or office) to enable access to a service provider's network (such as included in or in communication with the wireless communication network 100).

Some IoT devices, such as A-IoT devices (sometimes referred to as ultra-light IoT devices), may be associated with a relatively simple hardware design that may be designed to use low power and be implementable at low cost. For example, the UE 120d and/or the UE 120e may be A-IoT devices. As shown in FIG. 1, an A-IoT device may operate in the cell 130c, which may be referred to herein as an “A-IoT system” or an “A-IoT network.” The A-IoT device(s) may communicate with the network node 110c. For example, the network node 110c may be a reader (e.g., an A-IoT reader device). In other examples, the A-IoT devices may communicate with one or more other readers. A reader (e.g., an A-IoT reader device) may be a network node 110, a UE 120, or another wireless communication device. A-IoT technology may include passive IoT (such as NR passive IoT for 5G Advanced), semi-passive IoT, active IoT, or ultra-light IoT. In passive IoT, a terminal (such as a tag or a similar device) may not include a battery or other long-term energy storage, and the terminal may accumulate energy from radio signaling. In some examples, the terminal may accumulate solar or other energy to supplement accumulated energy from radio signaling. To achieve further cost reduction and zero-power communication, backscattering communication may be implemented at a type of passive IoT device referred to as an “ambient backscatter device” or a “backscatter device,” which may modulate a reflecting radio signal from an RF source to convey data. Some IoT devices may be referred to as semi-passive IoT devices. At a semi-passive IoT device, communication between a reader and the IoT device does not need to be preceded by an energy harvesting waveform. For example, a semi-passive IoT device may include a battery or similar energy source that can power the semi-passive IoT device. Some IoT devices may be referred to as active IoT devices. An active IoT device may have a battery or similar energy source and an active radio, allowing for active transmission and reception without energy harvesting or backscattering. A-IoT technology may be useful in connection with industrial sensors, for which battery replacement may be prohibitively difficult or undesirable (such as for safety monitoring or fault detection in smart factories, infrastructures, or environments). Additionally, features of A-IoT devices, such as low cost, small size, simple or infrequent maintenance, durability, and long lifespan, may facilitate smart logistics and warehousing (for example, in connection with automated asset management). Furthermore, A-IoT technology may be useful in connection with smart home networks for household item management, wearable devices, or similar applications. As an example, the cell 130c may be associated with a home network, a factory network, and/or a building network, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (SS) (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more TBs of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples.

In some aspects, the network node 110 may include a communication manager 155. As described in more detail elsewhere herein, the communication manager 155 may receive configuration information that indicates a frequency hopping pattern for an R2D signal; and transmit the R2D signal and one or more repetitions of a data block of the R2D signal on different carrier frequencies in accordance with the frequency hopping pattern.

Additionally, or alternatively, as described in more detail elsewhere herein, the communication manager 155 may receive, from an A-IoT reader device, capability information that indicates a frequency hopping capability of the A-IoT reader device; and transmit, to the A-IoT reader device, configuration information that indicates a frequency hopping pattern for an R2D signal and one or more repetitions of a data block of the R2D signal. Additionally, or alternatively, the communication manager 155 may perform one or more other operations described herein.

In some aspects, the UE 120 may include a communication manager 150. As described in more detail elsewhere herein, the communication manager 150 may receive configuration information that indicates a frequency hopping pattern for an R2D signal; and transmit the R2D signal and one or more repetitions of a data block of the R2D signal on different carrier frequencies in accordance with the frequency hopping pattern.

Additionally, or alternatively, as described in more detail elsewhere herein, the communication manager 150 may receive, from an A-IoT reader device, an R2D signal and one or more repetitions of a data block of the R2D signal on different carrier frequencies; and decode the data block of the R2D signal based on at least one of the R2D signal or the one or more repetitions.

Additionally, or alternatively, as described in more detail elsewhere herein, the communication manager 150 may receive, from an A-IoT reader device, capability information that indicates a frequency hopping capability of the A-IoT reader device; and transmit, to the A-IoT reader device, configuration information that indicates a frequency hopping pattern for an R2D signal and one or more repetitions of a data block of the R2D signal. Additionally, or alternatively, the communication manager 150 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

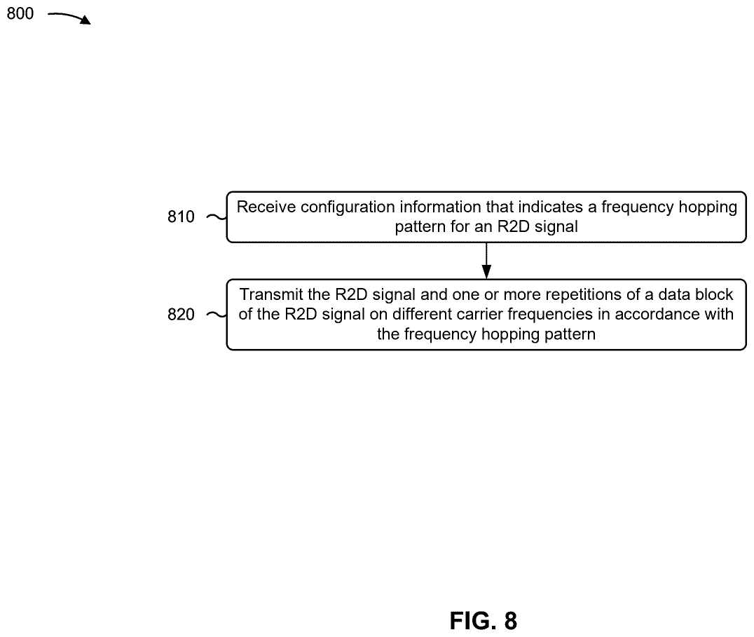

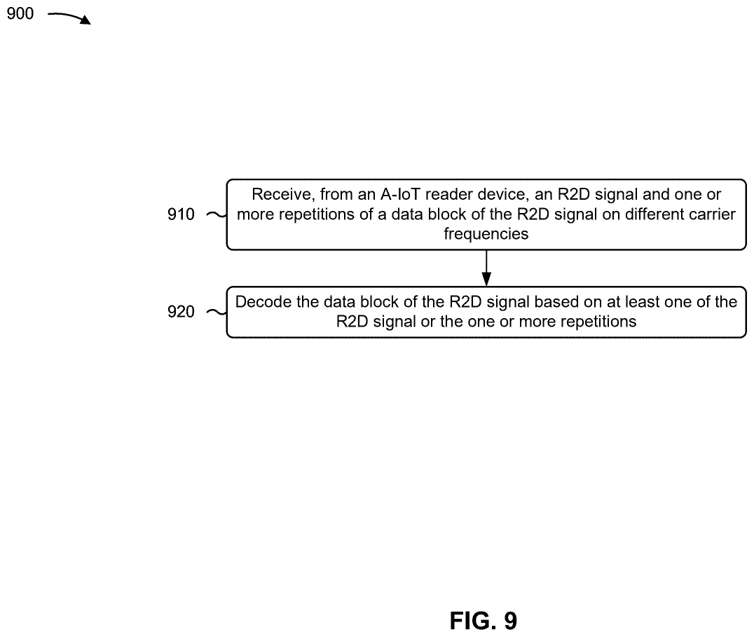

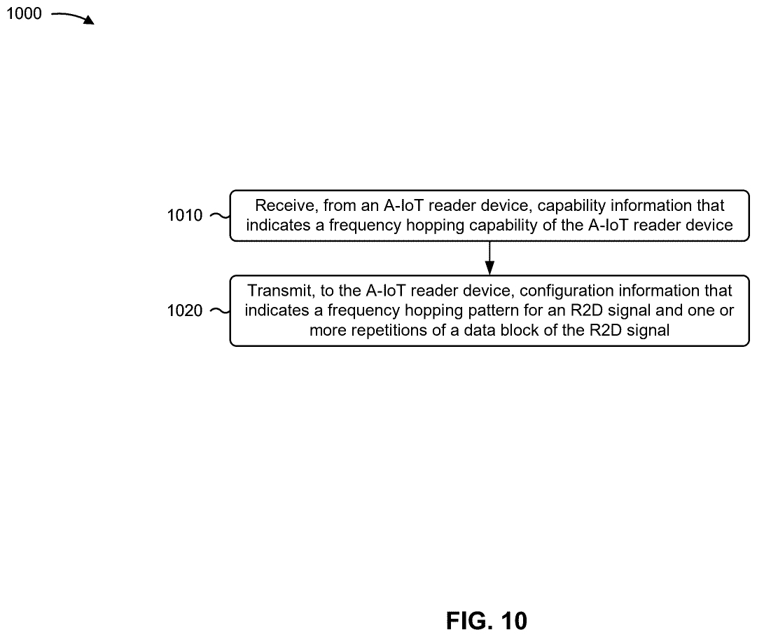

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with frequency hopping for A-IoT R2D repetitions, as described in more detail elsewhere herein. For example, the processing system 145 of the network node 110, the processing system 140 of the UE 120, the CU 210, the DU 230, or the RU 240 may perform or direct operations of, for example, process 800 of FIG. 8, process 900 of FIG. 9, process 1000 of FIG. 10, or other processes as described herein (alone or in conjunction with one or more other processors). In some aspects, the A-IoT reader device described herein is the network node 110, is included in the network node 110, or includes one or more components of the network node 110 described in connection with FIG. 1. In some aspects, the A-IoT reader device described herein is the UE 120, is included in the UE 120, or includes one or more components of the UE 120 described in connection with FIG. 1. In some aspects, the A-IoT device described herein is the UE 120, is included in the UE 120, or includes one or more components of the UE 120 described in connection with FIG. 1. In some aspects, the network device described herein is the network node 110, is included in the network node 110, or includes one or more components of the network node 110 described in connection with FIG. 1. In some aspects, the network device described herein is the UE 120, is included in the UE 120, or includes one or more components of the UE 120 described in connection with FIG. 1. Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 800 of FIG. 8, process 900 of FIG. 9, process 1000 of FIG. 10, or other processes as described herein. In some examples, executing instructions may include running the instructions, converting the instructions, compiling the instructions, and/or interpreting the instructions, among other examples.

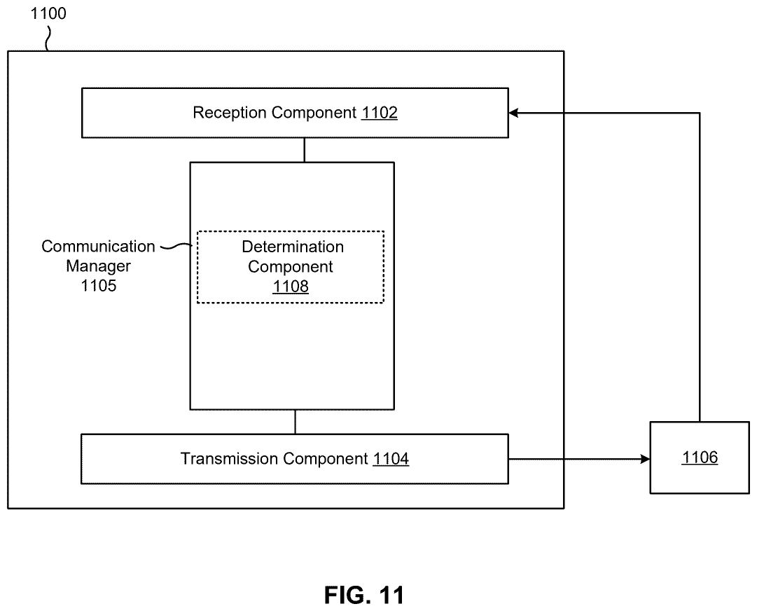

In some aspects, an A-IoT reader device (e.g., a network node 110 or a UE 120) includes means for receiving configuration information that indicates a frequency hopping pattern for an R2D signal; and/or means for transmitting the R2D signal and one or more repetitions of a data block of the R2D signal on different carrier frequencies in accordance with the frequency hopping pattern. In some aspects, the means for the A-IoT reader device to perform operations described herein may include, for example, one or more of a communication manager (e.g., communication manager 155 or communication manager 150), a processing system (e.g., processing system 145 or processing system 140), a radio, one or more RF chains, one or more transceivers, one or more antennas, one or more modems, a reception component (for example, reception component 1102 depicted and described in connection with FIG. 11), and/or a transmission component (for example, transmission component 1104 depicted and described in connection with FIG. 11), among other examples.

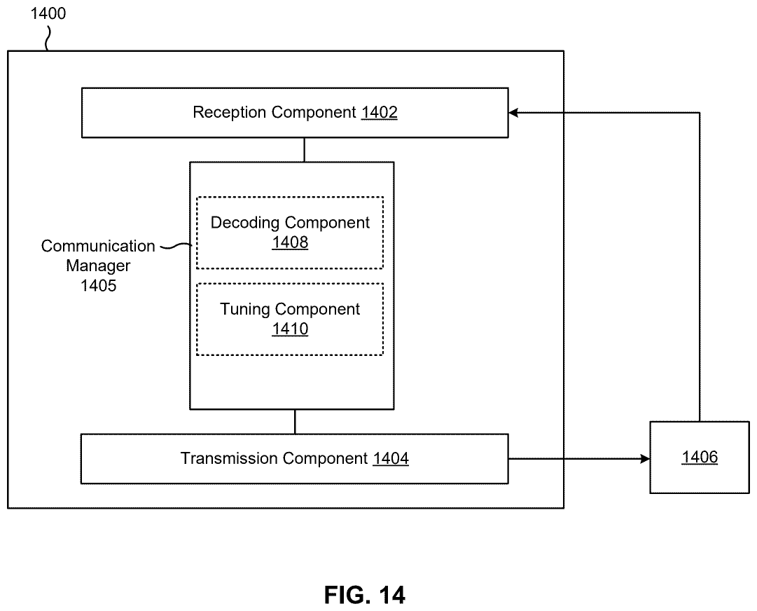

In some aspects, an A-IoT device (e.g., a UE 120) includes means for receiving, from an A-IoT reader device, an R2D signal and one or more repetitions of a data block of the R2D signal on different carrier frequencies; and/or means for decoding the data block of the R2D signal based on at least one of the R2D signal or the one or more repetitions. In some aspects, the means for the A-IoT device to perform operations described herein may include, for example, one or more of communication manager 150, processing system 140, a radio, one or more RF chains, one or more transceivers, one or more antennas, one or more modems, a reception component (for example, reception component 1402 depicted and described in connection with FIG. 14), and/or a transmission component (for example, transmission component 1404 depicted and described in connection with FIG. 14), among other examples.

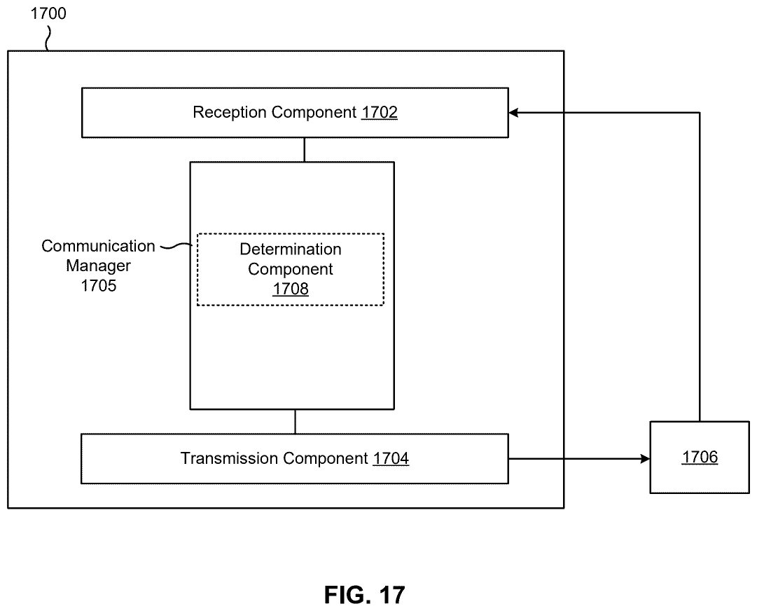

In some aspects, a network device (e.g., a network node 110 or a UE 120) includes means for receiving, from an A-IoT reader device, capability information that indicates a frequency hopping capability of the A-IoT reader device; and/or means for transmitting, to the A-IoT reader device, configuration information that indicates a frequency hopping pattern for an R2D signal and one or more repetitions of a data block of the R2D signal. In some aspects, the means for the network device to perform operations described herein may include, for example, one or more of a communication manager (e.g., communication manager 155 or communication manager 150), a processing system (e.g., processing system 145 or processing system 140), a radio, one or more RF chains, one or more transceivers, one or more antennas, one or more modems, a reception component (for example, reception component 1702 depicted and described in connection with FIG. 17), and/or a transmission component (for example, transmission component 1704 depicted and described in connection with FIG. 17), among other examples.

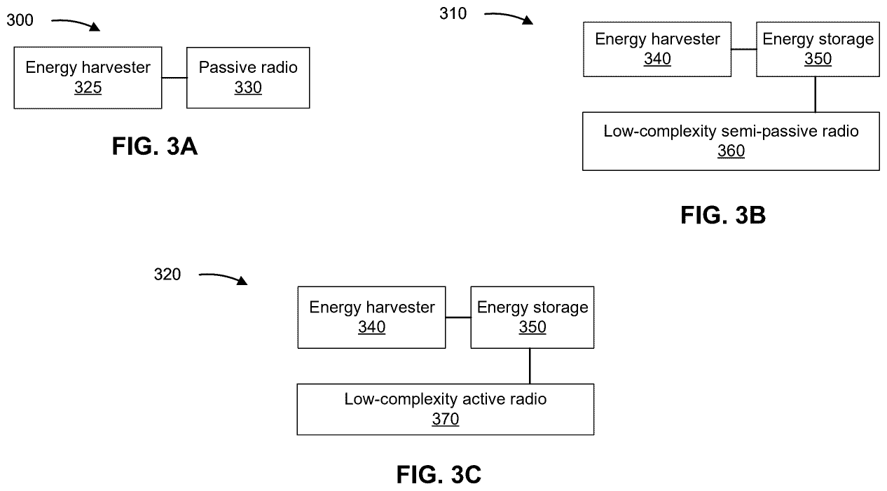

FIGS. 3A-3C are diagrams illustrating examples 300, 310, and 320 associated with different types of ambient IoT devices, in accordance with the present disclosure.

As shown in FIG. 3A, example 300 illustrates components of a passive ambient IoT device. As shown, passive ambient IoT devices may include an energy harvester 325 and a passive radio 330. For example, the passive radio 330 may be configured to backscatter a CW. For example, passive ambient IoT devices may not include energy storage. The passive ambient IoT devices may harvest energy (e.g., via the energy harvester 325) to power the passive radio 330 to enable the passive radio 330 to perform reception and transmission operations.

As shown in FIG. 3B, example 310 illustrates components of a semi-passive ambient IoT device. As shown, semi-passive ambient IoT devices may include an energy harvester 340, an energy storage 350, and/or a low-complexity semi-passive radio 360. For example, the low-complexity semi-passive radio 360 may be configured to harvest energy from a CW using the energy harvester 340, store energy from a CW using the energy storage 350, and/or backscatter a CW.

As shown in FIG. 3C, example 320 illustrates components of an active ambient IoT device. As shown, active ambient IoT devices may include an energy harvester 340, an energy storage 350, and/or a low-complexity (for example, low-cost) active radio 370. For example, the low-complexity active radio 370 may be configured to harvest energy from a CW using the energy harvester 340, store energy from a CW using the energy storage 350, and/or backscatter a CW.

Ambient IoT devices may be categorized into at least three types of devices: device 1, device 2a, and device 2b. Device 1 type ambient IoT devices may include at least some passive and/or semi-passive devices. A device 1 type ambient IoT device may have approximately 1 microwatt (μW) peak power consumption, support energy storage, use an initial sampling frequency offset (SFO) up to 10^{X} ppm (for example, where X can be any suitable value), and communicate uplink transmissions by backscattering externally-provided CWs.

Device 2a type ambient IoT devices may include at least some semi-passive devices, and device 2b type ambient IoT devices may include active devices. Both device 2a and device 2b type ambient IoT devices may have less than or equal to a few hundred μW peak power consumption, support energy storage, and use an initial SFO up to 10^{X} ppm. A device 2a type ambient IoT device may communicate uplink transmissions by backscattering externally-provided CWs. A device 2b type ambient IoT device may communicate uplink transmissions by internally generating the uplink transmission.

In some examples, device 1, device 2a, and/or device 2b type ambient IoT devices that are located indoors may support a maximum distance of 10-50 m, a range which may be sub-selected. In Topology 1 (for example, in which an ambient IoT device may directly and bidirectionally communicate with one or more network nodes 110) and in Topology 2 (for example, in which an ambient IoT device may communicate bidirectionally with an intermediate node between the ambient IoT device and a network node 110), device 1, device 2a, and/or device 2b type ambient IoT devices may not support RRC states, mobility (for example, cell-selection/re-selection-like functionality), automatic repeat request (ARQ), or HARQ.

As indicated above, FIGS. 3A-3C are provided as examples. Other examples may differ from what is described with respect to FIGS. 3A-3C.

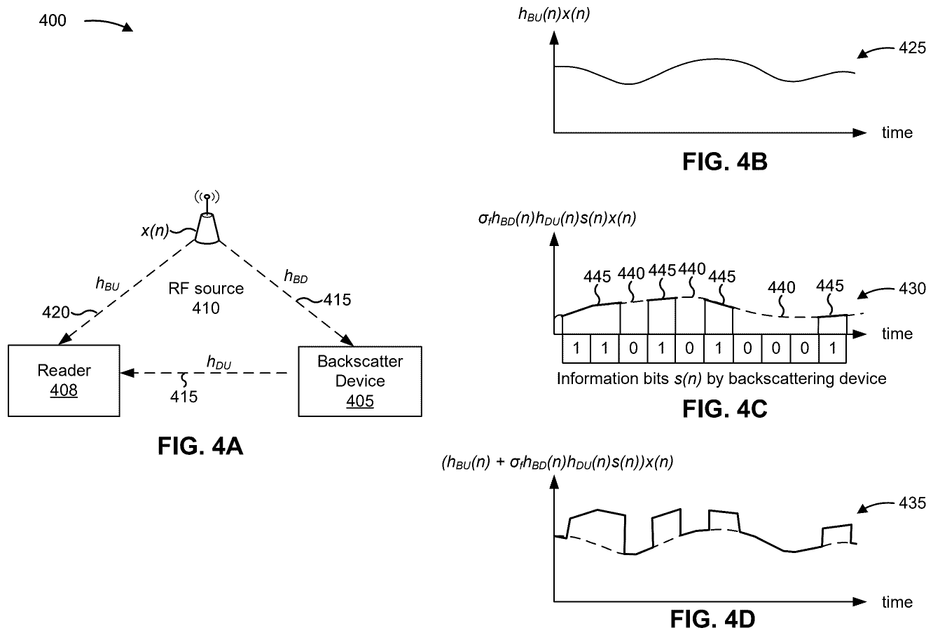

FIGS. 4A-4D are diagrams illustrating an example 400 associated with backscatter communications, in accordance with the present disclosure.

Some wireless communication devices may be considered IoT devices, such as ambient IoT devices (sometimes referred to as ultra-light IoT devices), or similar IoT devices. In ambient IoT, a terminal (for example, a radio frequency identification (RFID) device, a tag, or a similar device) may not include a battery, and the terminal may accumulate energy from radio signaling. To achieve further cost reduction and zero-power communication, wireless networks may utilize a type of ambient IoT device referred to as an “ambient backscatter device” or a “backscatter device.”

As shown in FIG. 4A, a backscatter device 405 (for example, a tag or a sensor, among other examples), which may be one example of an ambient IoT device such as a passive, semi-passive, or active ambient IoT device described with regard to FIG. 1 and FIG. 4, may employ a simplified hardware design (for example, including a power splitter, an energy harvester, and a microcontroller) that does not include a battery. For example, the backscatter device 405 may rely on energy harvesting for power and that may not include a radio wave generation circuit. In some examples, that the backscatter device 405 may have the capability to transmit information only by reflecting a radio wave. More particularly, the backscatter device 405 communicates with a reader 408 (for example, a UE 120, a network node 110 (e.g., the network node 110c), a network entity, or another network device) by modulating a reflecting radio signal from an RF source 410 (for example, a network node 110, a UE 120, or another network device). In some examples, the RF source 410 and the reader 408 may be the same device and/or may be co-located. For example, in some instances, the reader 408 and the RF source 410 may be associated with the same network node 110. In some examples, the backscatter device 405 may be referred to herein as a UE, such as a UE 120 (e.g., the UE 120d or the UE 120e).

To facilitate communication of the backscatter device 405, the RF source 410 may transmit an energy harvesting wave to the backscatter device 405. The energy harvesting wave may be transmitted for a sufficient duration in order to enable a communication phase for a target range between the reader 408 and the backscatter device 405. Additionally, or alternatively, in some instances, a range between the RF source 410 and the backscatter device 405 may be limited by a minimum received power for triggering energy harvesting at the backscatter device 405, such as −20 decibel milliwatts (dBm).

Once energy is sufficiently accumulated at the backscatter device 405, the backscatter device 405 may begin to reflect the radio wave that is radiated onto the backscatter device 405 via a backscatter link 415. For example, the RF source 410 may initiate a communication session (sometimes referred to as a query-response communication) with a query, which may be a modulating envelope of a CW. The backscatter device 405 may respond by backscattering of the CW. The communication session may include multiple rounds, such as for purposes of contention resolution when multiple backscatter devices respond to a query. A channel between the RF source 410 and the backscatter device 405 of the backscatter link 415 may be associated with a first backscatter link channel response value (sometimes referred to as a first backscatter link channel coefficient or a first backscatter link gain value), hBD. As described below, the backscatter device 405 may have reflection-on periods and reflection-off periods that follow a pattern that is based at least in part on the transmission of information bits by the backscatter device 405. The reader 408 may detect the reflection pattern of the backscatter device 405 and obtain the backscatter communication information via the backscatter link 415. A channel between the reader 408 and the backscatter device 405 of the backscatter link 415 may be associated with a second backscatter link channel response value (sometimes referred to as a second backscatter link channel coefficient or a second backscatter link channel gain value), hDU. In addition, the RF source 410 and the reader 408 may communicate (for example, reference signals and/or data signals) via a direct link 420. A channel between the RF source 410 and the reader 408 of the direct link 420 may be associated with a direct link channel response value (sometimes referred to as a direct link channel coefficient or a direct link channel gain value), hBU shown by reference number 425 in FIG. 4B.

Thus, the resulting signal received at the reader 408, which is the superposition of the signal received via the direct link 420 and the signal received via the backscatter link 415, may be denoted as y(n). This signal, y(n), is shown by reference number 435 in FIG. 4D. As shown, when s(n)=0 (indicated by reference number 440 in the plot shown at reference number 430 in FIG. 4C), the backscatter device 405 may switch off reflection, and thus the reader 408 receives only the direct link 420 signal. When s(n)=1 (indicated by reference number 445 in the plot shown at reference number 430 in FIG. 4C), the backscatter device 405 may switch on reflection, and thus the reader 408 receives a superposition of both the direct link 420 signal and the backscatter link 415 signal. To receive the information bits transmitted by the backscatter device 405, the reader 408 may first decode x(n) based at least in part on the direct link channel response value of hBU(n) by treating the backscatter link 415 signal as interference. The reader 408 may then detect the existence of the signal component.

As indicated above, FIGS. 4A-4D are provided as an example. Other examples may differ from what is described with respect to FIGS. 4A-4D.

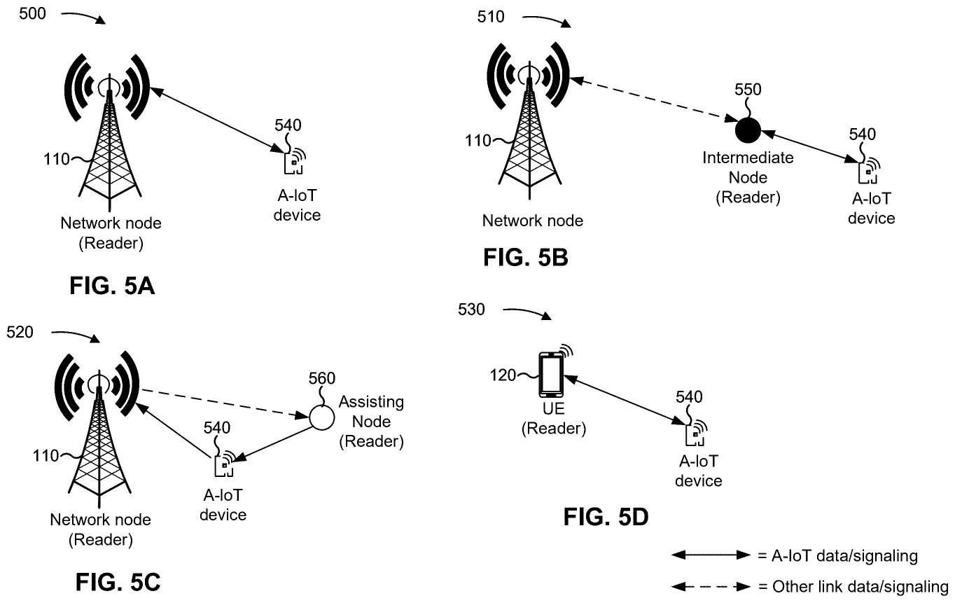

FIGS. 5A-5D are diagrams illustrating examples of topologies for ambient IoT devices, in accordance with the present disclosure. For example, FIG. 5A shows a first topology 500, FIG. 5B shows a second topology 510, FIG. 5C shows a third topology 520, and FIG. 5D shows a fourth topology 530. These topologies are provided as examples and A-IoT devices may be deployed in a wireless communication network (e.g., the wireless communication network 100) in other topologies in accordance with the aspects and techniques described herein. FIGS. 5A-5D show communication between an A-IoT device 540 (e.g., an A-IoT device similar to the device(s) described in connection with FIGS. 4 and 5) and a reader (for example, a network node 110, an intermediate node 550, an assisting node 560, and/or a UE 120, depending on the topology). The topologies depicted in FIGS. 5A-5D may be examples of A-IoT systems. For example, the topologies may be deployed in a wireless communication network (e.g., the wireless communication network 100), such as via the cell 130c.

The first topology 500 shown in FIG. 5A may be referred to as Topology 1. In Topology 1, the A-IoT device 540 may directly and bidirectionally communicate with one or more network nodes 110. For example, the A-IoT device 540 device and the one or more network nodes 110 may communicate A-IoT data and/or signaling. In some examples, a first network node 110 may transmit communications to the A-IoT device 540 and a second network node 110 may receive communications from the A-IoT device 540. In examples in which the A-IoT device 540 is deployed via the Topology 1, the network node 110 may be referred to as a reader (e.g., a reader as described in more detail elsewhere herein). For example, the Topology 1 may be a network node-based (or gNB-based) reader topology.

The second topology 510 shown in FIG. 5B may be referred to as Topology 2. In Topology 2, the A-IoT device 540 may communicate bidirectionally with an intermediate node 550 between the A-IoT device 540 and a network node 110. The intermediate node 550 may be any suitable device that has the capability to perform A-IoT-based communication, such as a relay, an IAB node, UE (for example, a UE 120), a network node (e.g., a network node 110), or repeater, among other examples. The intermediate node 550 may transfer A-IoT data and/or signaling between network node 110 and the A-IoT device. In examples in which the A-IoT device 540 is deployed via the Topology 2, the intermediate node 550 may be referred to as a reader (e.g., a reader as described in more detail elsewhere herein). The intermediate node 550 and the network node 110 may communicate via another link, such as an access link, a backhaul link, a midhaul link, a fronthaul link, or another communication link (e.g., and may communicate data and/or signaling (e.g., control signaling) via the other link). In some examples, in the Topology 1, the network node 110 may be referred to as a controller, such as a reader controller.

The third topology 520 shown in FIG. 5C may be referred to as Topology 3. In some examples, in Topology 3, the A-IoT device 540 device may transmit A-IoT data and/or signaling to a network node 110 and receive A-IoT data and/or signaling from an assisting node 560. In some examples, in Topology 3, the A-IoT device 540 may receive A-IoT data and/or signaling from the network node 110 and transmit A-IoT data and/or signaling to the assisting node 560. The assisting node may be any suitable device that has the capability for ambient IoT, such as a relay, an IAB node, UE (for example, a UE 120), a network node (e.g., a network node 110), or repeater, among other examples. In examples in which the A-IoT device 540 is deployed via the Topology 3, both the network node 110 and the assisting node 560 may be referred to as a reader (e.g., a reader as described in more detail elsewhere herein). The assisting node 560 and the network node 110 may communicate via another link, such as an access link, a backhaul link, a midhaul link, a fronthaul link, or another communication link (e.g., and may communicate data and/or signaling (e.g., control signaling) via the other link).

The fourth topology 530 shown in FIG. 5D may be referred to as Topology 4. In Topology 4, the A-IoT device 540 may bidirectionally communicate with a UE (e.g., a UE 120). For example, the A-IoT device 540 and the UE 120 may communicate A-IoT data and/or signaling. In examples in which the A-IoT device 540 is deployed via the Topology 4, the UE 120 may be referred to as a reader (e.g., a reader as described in more detail elsewhere herein).

As indicated above, FIGS. 5A-5D are provided as examples. Other examples may differ from what is described with respect to FIGS. 5A-5D.

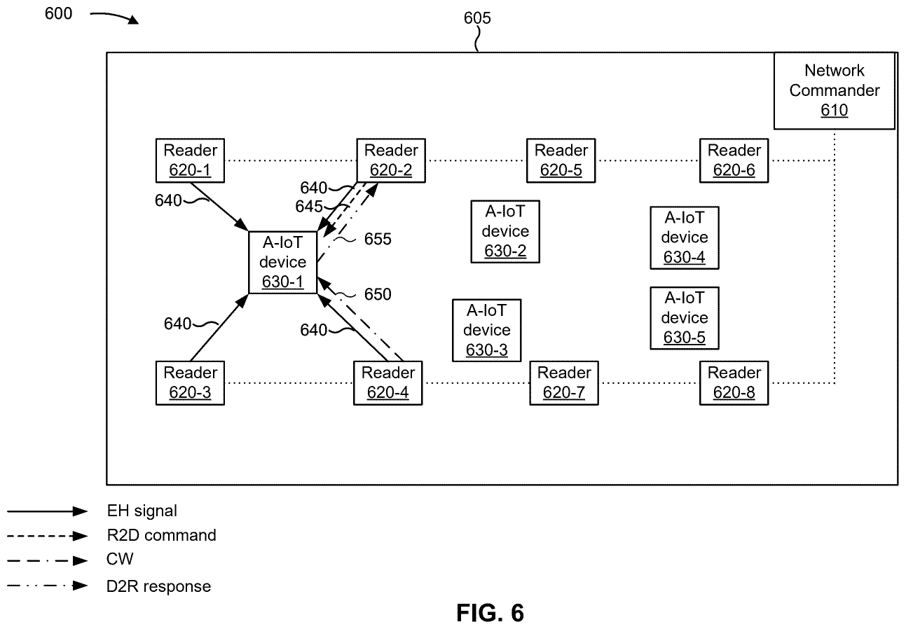

FIG. 6 is a diagram illustrating an example 600 of interference in an A-IoT system 605, in accordance with the present disclosure. The A-IoT system 605 may be, or may be included in, a wireless communication system, such as the wireless communication network 100. The A-IoT system 605 may include a cell, such as the cell 130c. In some examples, the A-IoT system 605 may be associated with a geographic area, such as a building, a warehouse, a factory, and/or a home, among other examples. In some examples, the A-IoT system 605 may be an indoor system configured to provide wireless connectivity within an indoor area, such as within a building, a warehouse, a factory, and/or a home, among other examples.

As shown in FIG. 6, the A-IoT system 605 may include a network commander 610 and multiple readers 620 (shown as reader 620-1 through reader 620-8). For example, the A-IoT system 605 may include a network of readers 620. The readers 620 may be A-IoT reader devices. In some examples, a reader 620 (e.g., an A-IoT reader device) may be a network node 110, a UE 120, an intermediate node (e.g., the intermediate node 550), and/or an assisting node (e.g., the assisting node 560), among other examples. In some examples, one or more of the readers 620 may be similar to the reader 408 and/or the RF source 410 discussed in connection with FIG. 4. In some examples, the A-IoT system 605 may be deployed one or more topologies described in connection with FIG. 5. In some examples, one or more of the readers 620 may be stationary readers. A stationary reader may be fixed at a certain location in the A-IoT system 605. For example, one or more of the readers 620 may be ceiling mounted readers. Additionally, or alternatively, one or more of the readers 620 may be mobile readers that have the capability to move to different locations in the A-IoT system 605. For example, one or more of the readers 620 may be handheld readers.

The network commander 610 may be configured to support the A-IoT system 605. The network commander 610 may be central control unit (e.g., a controller) configured to manage the A-IoT system 605. The network commander 610 may be a reader controller configured to manage, configure, and/or otherwise the readers 620 in the A-IoT system 605. For example, the network commander 610 may schedule and coordinate communications of all the readers 620 and/or collect data received (e.g., from one or more A-IoT devices 630) by the readers 620. In some examples, the network commander 610 may be, or may be included in, a network node 110. In some other examples, the network commander 610 may be, or may be included in, a UE 120. In some examples, the network commander 610 may be a separate network entity (e.g., a network node 110) from the readers 620 included in the A-IoT system 605. In some other examples, the network commander 610 may be, or may be included in, one of the readers 620 in the A-IoT system 605. In such examples, a network node 110 (e.g., a gNB may indicate a reader 620 that is to act as the network commander 610 to coordinate the other readers 620 and/or collect data from the other readers 620). In some examples, the network commander 610 may communicate with one or more of the readers 620 (e.g., one or more readers 620 that are network nodes 110) via a backhaul link (shown using dotted lines in FIG. 6). Additionally, or alternatively, the network commander 610 may communicate with one or more of the readers 620 (e.g., one or more readers 620 that are UEs 120) via a Uu interface (e.g., via downlink and/or uplink communications).

The A-IoT system 605 may include one or more A-IoT devices 630 (shown in FIG. 6 as A-IoT device 630-1 through A-IoT device 630-5 as an example). The readers 620 and the one or more A-IoT devices 630 may be physically dispersed throughout the A-IoT system 605. In some examples, the A-IoT devices 630 may be mobile devices or may be attached to moveable objects such that physical locations of the A-IoT devices 630 within the A-IoT system 605 may change over time. For example, an A-IoT device may be a tag attached to a physical object (e.g., for product or inventory tracking in a case in which the A-IoT system 605 is deployed in a store or warehouse).

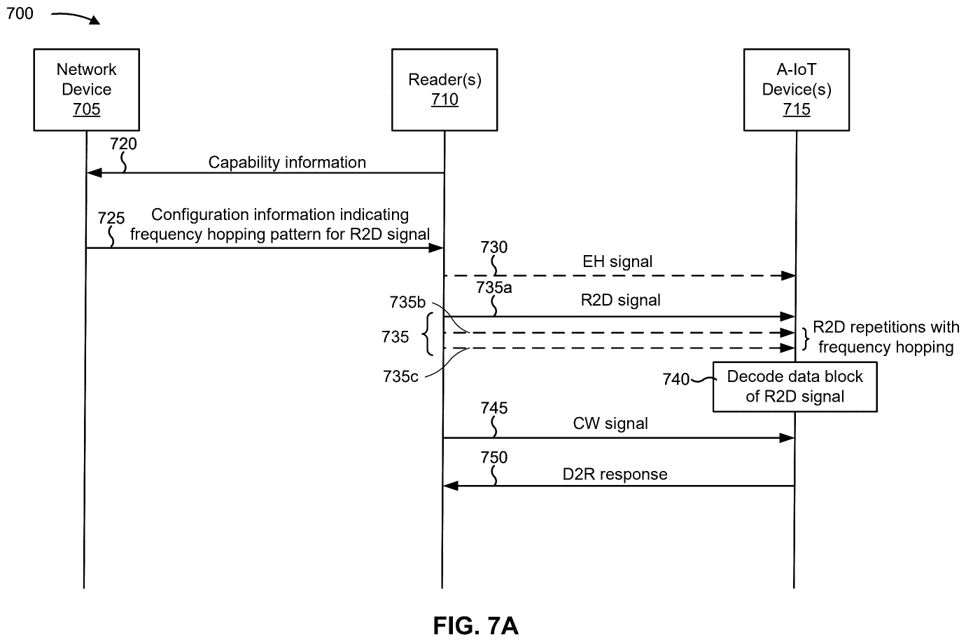

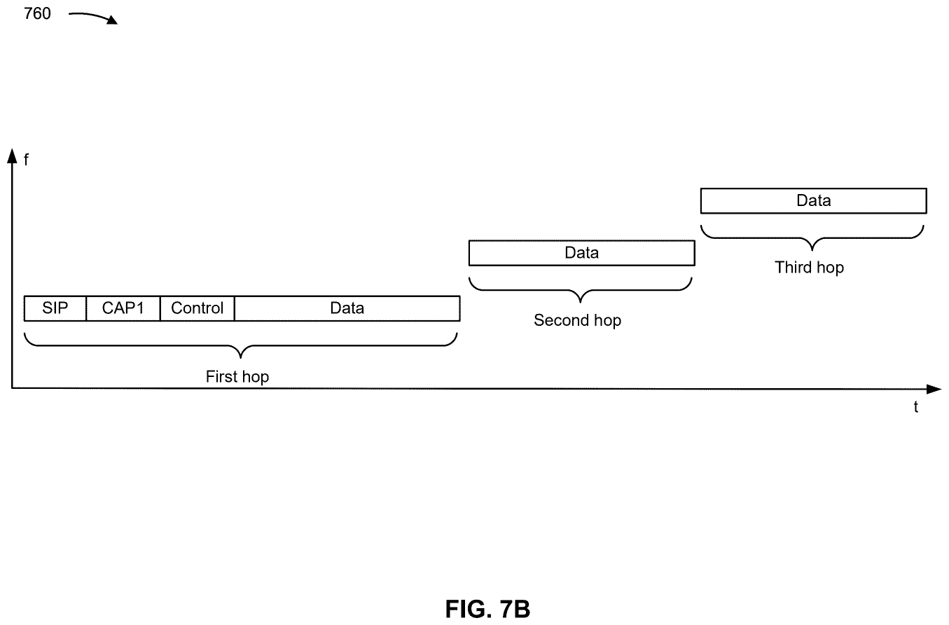

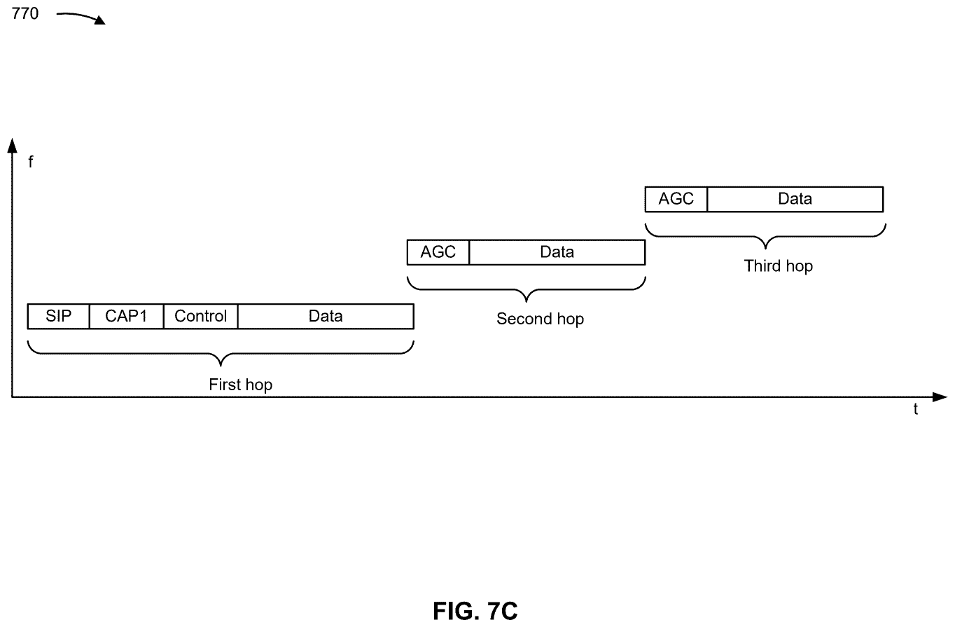

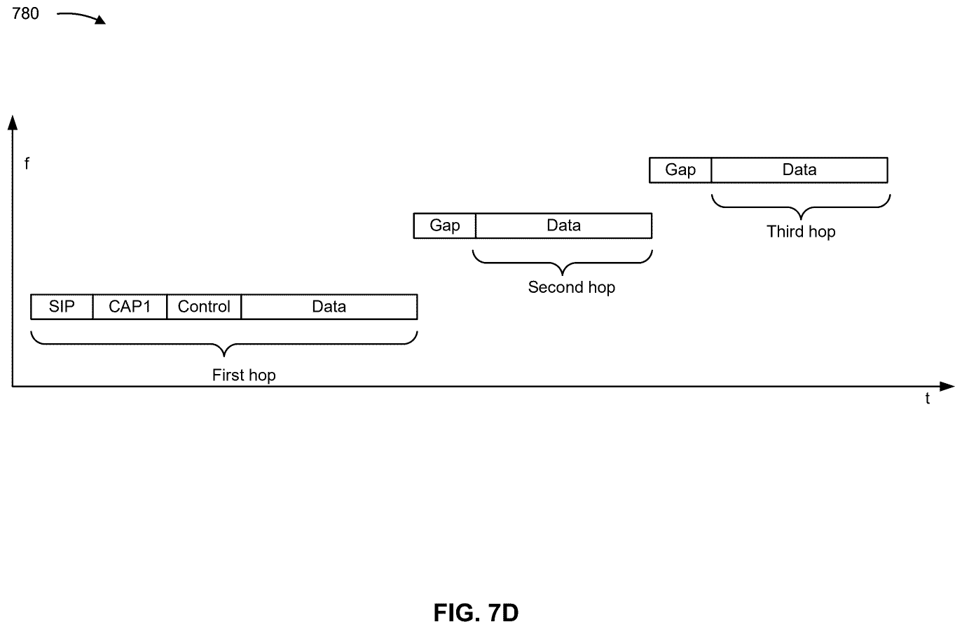

In some examples, the readers 620 may operate in different modes to perform different actions for bistatic communication with the one or more A-IoT devices 630 depending on scheduling decisions by the network commander 610. As shown in FIG. 6, a reader 620 may transmit an EH signal (e.g., an energizing signal) to provide energy to an A-IoT device 630. As shown by reference number 640, readers 620-1, 620-2, 620-3, and 620-4 may each transmit an EH signal, and A-IoT device 630-1 may harvest energy from the EH signals transmitted by readers 620-1, 620-2, 620-3, and 620-4. As shown by reference number 645, a reader 620 (e.g., reader 620-2) may transmit an R2D command to an A-IoT device 630 (e.g., A-IoT device 630-1). The R2D command may include one or more signals transmitted from a reader 620 to an A-IoT device 630 via a forward link. The R2D command may also be referred to as an R2D signal or an R2D message. In some aspects, the reader 620 (e.g., reader 620-2) may transmit multiple repetitions of the R2D command. For example, the reader 620 may transmit an initial R2D signal that includes a data block (e.g., including the R2D command), and one or more repetitions of the data block of the R2D signal. In some aspects, as described in greater detail in connection with FIGS. 7A-7D, the reader 620 (e.g., reader 620-2) may transmit the initial transmission of the R2D signal and the one or more repetitions of the data block of the R2D signal on different carrier frequencies in accordance with a frequency hopping pattern. As shown by reference number 650, a reader 620 (e.g., reader 620-4) may transmit a CW signal to an A-IoT device 630 (e.g., A-IoT device 630-1) via the forward link. The CW signal may be a continuous signal (e.g., a continuous wave signal). As shown by reference number 655, the A-IoT device 630 (e.g., A-IoT device 630-1) may transmit a D2R response to a reader 620 (e.g., reader 620-2). The D2R response may include one or more signals transmitted (e.g., reflected) from an A-IoT device 630 to a reader 620 via a backscatter link, such as the backscatter link 415 described in connection with FIG. 4. For example, an A-IoT device 630 (e.g., A-IoT device 630-1) may transmit the D2R response to a reader (e.g., reader 620-2) by reflecting a signal received via the forward link (e.g., the CW signal received from reader 620-4) as a backscatter signal in a similar manner as described elsewhere herein, such as in connection with FIG. 4. The D2R response may be, or may include, a response to the R2D command. The D2R response may also be referred to as a D2R signal or a D2R message.

In some examples, communications between the readers 620 and the A-IoT devices 630 in the A-IoT system 605 may occur over multiple steps. In such examples, communications between a reader 620 and an A-IoT device 630 may include multiple R2D signals (e.g., R2D commands) and multiple D2R signals (e.g., D2R responses). For example, a reader 620 and an A-IoT device 630 in the A-IoT system 605 may communicate using a multi-step approach similar to communications performed in an RFID system (e.g., an RFID inventory system). In such a multi-step approach, the reader 620 may send a query (e.g., via an R2D signal) to an A-IoT device 630 (e.g., a tag) in a first step. In a second step, the A-IoT device 630 (e.g., the tag) may respond (via a D2R signal) with a random number (e.g. a 16-bit number). In a third step, the reader 620 may send (e.g., via another R2D signal) an ACK including the number (e.g., the 16-bit number) received from the A-IoT device 630. In a fourth step, the A-IoT device 630 (e.g., the tag) may respond (e.g., via another D2R signal) with requested information associated with the A-IoT device 630, such as an electronic product code (EPC) associated with the A-IoT device 630 (e.g., the tag) or another identifier associated with the A-IoT device 630. In another example, communications between a reader 620 and an A-IoT device 630 may occur over multiple steps in a four step RACH procedure.

As indicated above, FIG. 6 is provided as an example. Other examples may differ from what is described with respect to FIG. 6.

FIGS. 7A-7D are diagrams illustrating examples associated with frequency hopping for A-IoT R2D repetitions, in accordance with the present disclosure. As shown in FIG. 7A, example 700 includes communication between a network device 705, one or more readers 710, and one or more A-IoT devices 715. The network device 705 may be a network commander (e.g., network commander 610) central control unit (e.g., a controller), a reader controller, a network node 110, a UE 120, or another device. The reader 710 may be an A-IoT reader device, a reader 620, a network node 110, a UE 120, an intermediate node (e.g., the intermediate node 550), and/or an assisting node (e.g., the assisting node 560), among other examples. The A-IoT device 715 may be an A-IoT device 630, an EH-capable device, an A-IoT device 540, a UE 120, a RedCap UE, and/or a backscatter device (e.g., the backscatter device 405), among other examples. In some aspects, the network device 705, the reader(s) 710, and/or the A-IoT device(s) 715 may be part of a wireless network (e.g., the wireless communication network 100).

In some aspects, the reader(s) 710 and the A-IoT device(s) 715 may be part of an A-IoT system (e.g., similar to the A-IoT system 605 discussed in connection with FIG. 6). The reader(s) 710 may be included in a network of readers 710 deployed in the A-IoT system. The network device 705 may be configured to configure, manage, schedule communications for, and/or otherwise control the one or more readers 710. In some aspects, the network device 705 may allocate resources (e.g., time and/or frequency resources) to the one or more readers 710 to be used for communications (e.g., monostatic and/or bistatic communications) with one or more A-IoT devices 715.

As shown in FIG. 7A, and by reference number 720, the reader 710 may transmit (e.g., send or provide), and the network device 705 may receive (e.g., obtain), capability information. The capability information may be included in a capability message or capability report. The reader 710 may transmit the capability message (or capability report) indicating the capability information via an uplink communication, a sidelink communication, a backhaul communication, an Xn interface communication, a unicast communication, a broadcast communication, a UE assistance information (UAI) communication, a UCI communication, a sidelink control information (SCI) communication, a MAC-CE communication, an RRC communication, a PUCCH, a PUSCH, a physical sidelink control channel (PSCCH), and/or a physical sidelink shared channel (PSSCH), among other examples. The capability information may indicate one or more parameters associated with respective capabilities of the reader 710. The one or more parameters may be indicated via respective information elements (IEs) included in the capability message (or capability report).

In some aspects, the capability information may indicate a frequency hopping capability of the reader 710. For example, the capability information may indicate whether the reader 710 supports frequency hopping for R2D repetitions. Additionally, or alternatively, the capability information (e.g., the frequency hopping capability of the reader 710) may indicate a capability of the reader 710 for transmitting R2D repetitions (e.g., an initial transmission of an R2D signal and one or more repetitions of at least a data block of the R2D signal) with frequency hopping with or without time gaps between the hops (e.g., the R2D repetitions) on different carrier frequencies. For example, different readers 710 may have different capabilities for tuning between transmission of different carrier frequencies. Some readers 710 may require some tuning time (e.g., a time gap) between transmissions on different carrier frequencies to change from one carrier frequency to another carrier frequency. Some other readers 710 may not require any time gap between transmissions on different carrier frequencies. Accordingly, in some examples, the capability information may indicate that the reader 710 is capable of transmitting R2D repetitions with frequency hopping without time gaps between the hops (e.g., the reader 710 does not require a time gap between transmissions on different carrier frequencies). In some other examples, the capability information may indicate the reader 710 is capable of transmitting R2D repetitions with frequency hopping with time gaps between the hops (e.g., the reader 710 requires a time gap for tuning between transmissions on different carrier frequencies). In such examples, the capability information may indicate a tuning time for the reader 710 to tune between different carrier frequencies (e.g., a time gap duration associated with the reader 710).

As further shown in FIG. 7A, and by reference number 725, the network device 705 may transmit (e.g., send or provide), and the reader 710 may receive (e.g., obtain), configuration information that indicates a frequency hopping patter for an R2D signal. In some aspects, the configuration information may be based at least in part on the capability information. In some aspects, the network device 705 may transmit the configuration information via one or more of system information signaling (e.g., a master information block (MIB) and/or a system information block (SIB), among other examples), RRC signaling, MAC signaling (e.g., one or more MAC-CEs), DCI, and/or signaling via a backhaul link, among other examples. In some examples, for a Topology 2 deployment in which the reader 710 is a UE (e.g., UE 120), the configuration information that indicates the frequency hopping pattern may be transmitted by the network device 705, and received by the reader 710, via RRC signaling. That is, for such a Topology 2 deployment, the frequency hopping pattern may be RRC defined for the reader 710 (e.g., the UE reader).

The configuration information may indicate the frequency hopping pattern for an R2D signal. The frequency hopping pattern may indicate different carrier frequencies (e.g., frequency resources) to be used for different transmissions of R2D repetitions. For example, the frequency hopping pattern may indicate a different carrier frequency to be used for each of an initial transmission of an R2D signal and one or more repetitions of at least a data block of the R2D signal. In some aspects, the configuration information (e.g., the frequency hopping pattern) may indicate a quantity of the one or more repetitions. In some examples, the one or more repetitions may include multiple repetitions of at least the data block of the R2D signal (e.g., in addition to the initial transmission of the R2D signal).

In some aspects, the configuration information (e.g., the frequency hopping pattern) may indicate time resources for transmitting the R2D signal (e.g., the initial transmission of the R2D signal) and the one or more repetitions (e.g., the one or more repetitions of at least the data block of the R2D signal). In some examples, the time resources for the initial transmission of the R2D signal may include time resources (e.g., one or more symbols) for transmission of a start indicator part (SIP) of the R2D signal, time resources (e.g., one or more symbols) for transmission of a clock acquisition part (CAP) of the R2D signal, time resources (e.g., one or more symbols) for transmission of control information of the R2D signal, and time resources (e.g., one or more symbols) for transmission of a data block (e.g., a TB) of the R2D signal. Each repetition, of the one or more repetitions, may include at least the data block of the R2D signal. In some examples, each repetition, of the one or more repetitions, may include only the data block of the R2D signal (e.g., without the SIP, the CAP, and the control information included in the initial transmission of the R2D signal). In such examples, the time resources for each repetition may include time resources for transmission of the data block of the R2D signal. In some other examples, each repetition, of the one or more repetitions, may include a repetition of the entire R2D signal (e.g., the SIP, the CAP, the control information, and the data block). In such examples, the time resources for each repetition may include time resources for transmission of the SIP, the CAP, the control information, and the data block.

In some aspects, the time resources for each repetition, of the one or more repetitions, may include one or more AGC symbols. The one or more AGC symbols are time resources for transmission of an AGC signal that may be used by a receiver device (e.g., an A-IoT device 715) to perform AGC. For example, the time resources for each repetition may include one or more AGC symbols and time resources (e.g., one or more symbols) for transmission of the data block of the R2D signal.

In some aspects, the time resources for transmitting the R2D signal (e.g., the initial transmission of the R2D signal) and the one or more repetitions (e.g., the one or more repetitions of at least the data block of the R2D signal) may be configured based at least in part on the frequency hopping capability of the reader 710 indicated in the capability information. In some examples, the time resources for transmitting the R2D signal and the one or more repetitions may include time gaps between the different hops on different carrier frequencies (e.g., time gaps between the initial transmission of the R2D signal and a first repetition and between each consecutive pair of repetitions). For example, the time resources for transmitting the R2D signal and the one or more repetitions may indicate a time gap preceding each repetition of the one or more repetitions. In such examples, the configuration information may indicate the time resources including the time gaps based at least in part on the capability information indicating that the reader 710 is capable of frequency hopping with time gaps. In such examples, the duration of the time gaps may be based at least in part on the capability information. In some other examples, the time resources for transmitting the R2D signal and the one or more repetitions may not include time gaps between the hops on different carrier frequencies. In such example, the configuration information may indicate the time resources without the time gaps based at least in part on the capability information indicating that the reader 710 is capable of frequency hopping without time gaps.

As further shown in FIG. 7A, and by reference number 730, in some aspects, the reader 710 may transmit (e.g., send or provide) an EH signal. In some examples, the reader 710 may transmit the EH signal in accordance with the configuration information received from the network device 705. For example, the configuration information may indicate resources (e.g., time and/or frequency resources) for transmission of the EH signal by the reader 710, and the reader 710 may transmit the EH signal in the resources, indicated in the configuration information, for transmission of the EH signal. The reader 710 may transmit the EH signal to one or more A-IoT devices 715 to provide energy for the A-IoT device(s) 715.

In some aspects, multiple readers 710 may transmit the EH signal. For example, the network device 705 may configure (e.g., via the configuration information) multiple readers 710 with resources for transmission of the EH signal. In such examples, the multiple readers 710 may transmit the EH signal to one or more A-IoT devices 715 to provide energy for the A-IoT device(s) 715.

In some aspects, an A-IoT device 715 (or multiple A-IoT devices 715) may perform energy harvesting using the EH signal transmitted by the reader(s) 710.

As further shown in FIG. 7A, and by reference number 735, the reader 710 may transmit (e.g., send or provide) an R2D signal (shown by 735a) and one or more repetitions (shown by 735b and 735c) of a data block of the R2D signal. The reader 710 may transmit the R2D signal and the one or more repetitions of the data block of the R2D signal one different carrier frequencies in accordance with the frequency hopping pattern indicated in the configuration information. Each transmission (e.g., the initial transmission of the R2D signal and each repetition) may be transmitted by the reader 710 on a different carrier frequency and may be referred to as a respective hop. For example, a first hop may refer to the initial transmission of the R2D signal on a first carrier frequency, a second hop may refer to the transmission of a first repetition of at least the data block of the R2D signal on a second carrier frequency, a third hop may refer to the transmission of a second repetition of at least the data block of the R2D signal on a third carrier frequency, and so on.

The reader 710 may transmit the R2D signal and the one or more repetitions of the data block of the R2D signal to or toward (e.g., in a direction of) an A-IoT device 715. The A-IoT device 715 may receive the R2D signal and/or one or more repetitions of the data block of the R2D signal. In some aspects, the A-IoT device 715 may include a wideband receiver such that the A-IoT device 715 may not need to perform frequency tuning to receive the R2D signal and the one or more repetitions on the different carrier signals.

In some aspects, R2D signal may be or may include an R2D command. In some examples, the data block of the R2D signal may include the R2D command. The R2D command may include or indicate a query for information or data associated with an A-IoT device 715 (e.g., information identifying the A-IoT device 715 and/or data stored at the A-IoT device 715, among other examples). For example, each repetition of the data block of the R2D signal may include the same query for the information or the data associated with an A-IoT device 715. In some examples, the R2D command may indicate a time domain resource allocation associated with a D2R response to be transmitted by the A-IoT device 715.

The reader 710 may transmit the R2D signal and the one or more repetitions in accordance with the configuration information (e.g., the frequency resources and the time resources indicated in the configuration information). The quantity of repetitions may be indicated in the configuration information. In some examples, the one or more repetitions include multiple repetitions. FIGS. 7B-7D shows examples 760, 770, and 780 associated with the reader 710 transmitting the R2D signal and the repetitions (e.g., two repetitions are shown in each example of FIGS. 7B-7D). As shown in the examples 760, 770, and 780, the R2D signal transmitted in the first hop (e.g., on a first carrier frequency) may include a SIP, a CAP (shown as “CAP1”), control information (shown as “Control”), and a data block (shown as “Data”). The data block may indicate a data query (e.g., a query for information or data from an A-IoT device 715). The SIP indicates a start of the R2D signal. The CAP may be used by an A-IoT device for estimating the number of chips per symbol and/or a value of M for on-off keying (OOK) (e.g., OOK-4) for the data query. As shown in example 760 of FIG. 7B, in some aspects, each repetition (e.g., the second hop transmitted on a second carrier frequency and the third hop transmitted on a third carrier frequency) may include the data block of the R2D signal. In some other aspects, each repetition may include the entire R2D signal (e.g., the SIP, the CAP, the control information, and the data block).

As shown in example 770 of FIG. 7C, in some aspects, each repetition (e.g., the second hop transmitted on a second carrier frequency and the third hop transmitted on a third carrier frequency) may include one or more AGC symbols and the data block of the R2D signal. The reader 710 may transmit an AGC signal in the one or more AGC symbols. The A-IoT device 715 that receives the R2D signal and the repetitions may include a wideband receiver such that the A-IoT device 715 does not need to perform frequency tuning to receive the R2D signal and the repetitions on different carrier frequencies. However, in some examples, the antenna gain of the receiver of the A-IoT device 715 may not be flat for different frequencies and/or different frequencies may be affected differently by interference. In some aspects, the A-IoT device 715 may perform AGC based at least in part on the AGC symbols (e.g., the AGC signal transmitted by the reader 710 in the one or more AGC symbols). For example, the A-IoT device 715 may tune a comparator threshold of the A-IoT device 715 based at least in part on the one or more AGC symbols included in each repetition so that the A-IoT device 715 can process the bits received on the corresponding carrier frequency correctly (e.g., to accurately determine whether each bit is zero or one).

As shown in example 780 of FIG. 7D, in some aspects, each repetition of the data block of the R2D signal (e.g., the second hop transmitted on a second carrier frequency and the third hop transmitted on a third carrier frequency) may be preceded by a time gap. In such examples, the time resources for transmitting the R2D signal and the repetitions indicated in the configuration information may include a time gap between each hop (e.g., a time gap between each transmission on a different carrier frequency). Such time gaps may enable the reader 710 sufficient tuning time to switch from transmitting on one carrier frequency to transmitting on another carrier frequency. In such examples, the time resources including the time gaps may be configured based at least in part on the frequency hopping capability for the reader 710 indicated in the capability information. In some other aspects, the time resources for transmitting the R2D signal and the repetitions may not include time gaps between the hops (e.g., the transmissions on different carrier frequencies). For example, the time resources without the time gaps may be configured based at least in part on the frequency happing capability for the reader 710 indicated in the capability information.

As further shown in FIG. 7A, and by reference number 740, the A-IoT device 715 may decode the data block of the R2D signal. The A-IoT device 715 may decode the data block of the R2D signal based on the R2D signal and/or the one or more repetitions of the data block of the R2D signal received from the reader 710. In some examples, the A-IoT device 715 may decode the data block based on a combination of multiple data blocks received on different carrier frequencies (e.g., via the R2D signal and/or the one or more repetitions). In some examples, the A-IoT device 715 may decode the data block received via a best transmission (e.g., a transmission with a strong signal and/or best signal quality, among other examples) received at the A-IoT device 715 among the R2D signal and the one or more repetitions.

As further shown in FIG. 7A, and by reference number 745, a reader 710 may transmit (e.g., send or provide), and the A-IoT device 715 may receive (e.g., obtain), a CW signal. In some examples, such as in an example of monostatic A-IoT communications, the reader 710 that that transmits the CW signal may be the same as the reader 710 that transmits the R2D signal and the one or more repetitions of the data block of the R2D signal. In some other examples, such as in an example of bistatic A-IoT communications, the reader 710 that transmits the CW signal may be different from the reader 710 that transmits the R2D signal and the one or more repetitions of the data block of the R2D signal.

As further shown in FIG. 7A, and by reference number 750, the A-IoT device 715 may transmit (e.g., send or provide), and the reader 710 (e.g., the reader 710 that transmitted the R2D signal and the one or more repetitions of the data block of the R2D signal) may receive (e.g., obtain), a D2R response. The D2R response may be a response to the R2D command (e.g., the query for data or information) included in the data block of the R2D signal. For example, the A-IoT device 715 may transmit the D2R response to the reader 710 based at least in part on the A-IoT device 715 decoding the data block of the R2D signal and obtaining the R2D command. In some aspects, the D2R response may include information or data associated with the A-IoT device 715 (e.g., information identifying the A-IoT device 715, data generated by the A-IoT device 715, and/or data stored at the A-IoT device 715, among other examples). For example, the D2R response may include information or data associated with the A-IoT device 715 in connection with the query for the information or data associated with the A-IoT device 715 indicated or included in the R2D command. In some aspects, the D2R response may be a backscattered signal resulting from the A-IoT device 715 backscattering the CW signal. Accordingly, the A-IoT device 715 may receive the CW signal, and the A-IoT device 715 may transmit the D2R response by backscattering the CW signal.

As indicated above, FIGS. 7A-7D are provided as examples. Other examples may differ from what is described with respect to FIGS. 7A-7D.

FIG. 8 is a diagram illustrating an example process 800 performed, for example, at an A-IoT reader device or an apparatus of an A-IoT reader device, in accordance with the present disclosure. Example process 800 is an example where the apparatus or the A-IoT reader device (e.g., reader 710) performs operations associated with frequency hopping for A-IoT R2D repetitions.

As shown in FIG. 8, in some aspects, process 800 may include receiving configuration information that indicates a frequency hopping pattern for an R2D signal (block 810). For example, the A-IoT reader device (e.g., using communication manager 1105 and/or reception component 1102, depicted in FIG. 11) may receive configuration information that indicates a frequency hopping pattern for an R2D signal, as described above.

As further shown in FIG. 8, in some aspects, process 800 may include transmitting the R2D signal and one or more repetitions of a data block of the R2D signal on different carrier frequencies in accordance with the frequency hopping pattern (block 820). For example, the A-IoT reader device (e.g., using communication manager 1105 and/or transmission component 1104, depicted in FIG. 11) may transmit the R2D signal and one or more repetitions of a data block of the R2D signal on different carrier frequencies in accordance with the frequency hopping pattern, as described above.

Process 800 may include additional aspects, such as any single aspect or any combination of aspects described below and/or in connection with one or more other processes described elsewhere herein.

In a first aspect, receiving the configuration information includes receiving the configuration information via RRC signaling.

In a second aspect, alone or in combination with the first aspect, the R2D signal includes an SIP, a CAP, control information, and the data block.

In a third aspect, alone or in combination with one or more of the first and second aspects, each repetition, of the one or more repetitions, includes one or more automatic gain control symbols and the data block of the R2D signal.

In a fourth aspect, alone or in combination with one or more of the first through third aspects, the configuration information indicates time resources for transmission of the R2D signal and the one or more repetitions of the R2D signal.

In a fifth aspect, alone or in combination with one or more of the first through fourth aspects, the time resources indicate a time gap preceding each repetition of the one or more repetitions.

In a sixth aspect, alone or in combination with one or more of the first through fifth aspects, process 800 includes transmitting capability information that indicates a frequency hopping capability of the A-IoT reader device, wherein the time resources are based at least in part on the capability information.

In a seventh aspect, alone or in combination with one or more of the first through sixth aspects, the configuration information indicates a quantity of the one or more repetitions.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at an A-IoT device or an apparatus of an A-IoT device, in accordance with the present disclosure. Example process 900 is an example where the apparatus or the A-IoT device (e.g., A-IoT device 715) performs operations associated with frequency hopping for A-IoT R2D repetitions.

As shown in FIG. 9, in some aspects, process 900 may include receiving, from an A-IoT reader device, an R2D signal and one or more repetitions of a data block of the R2D signal on different carrier frequencies (block 910). For example, the A-IoT device (e.g., using communication manager 1405 and/or reception component 1402, depicted in FIG. 14) may receive, from an A-IoT reader device, an R2D signal and one or more repetitions of a data block of the R2D signal on different carrier frequencies, as described above.

As further shown in FIG. 9, in some aspects, process 900 may include decoding the data block of the R2D signal based on at least one of the R2D signal or the one or more repetitions (block 920). For example, the A-IoT device (e.g., using communication manager 1405 and/or decoding component 1408, depicted in FIG. 14) may decode the data block of the R2D signal based on at least one of the R2D signal or the one or more repetitions, as described above.

Process 900 may include additional aspects, such as any single aspect or any combination of aspects described below and/or in connection with one or more other processes described elsewhere herein.

In a first aspect, the R2D signal includes an SIP, a CAP, control information, and the data block.

In a second aspect, alone or in combination with the first aspect, each repetition, of the one or more repetitions, includes one or more automatic gain control symbols and the data block of the R2D signal.

In a third aspect, alone or in combination with one or more of the first and second aspects, process 900 includes tuning a comparator threshold based at least in part on the one or more automatic gain control symbols included in each repetition of the one or more repetitions.

In a fourth aspect, alone or in combination with one or more of the first through third aspects, consecutive repetitions, of the one or more repetitions, are separated by a time gap.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network device or an apparatus of a network device, in accordance with the present disclosure. Example process 1000 is an example where the apparatus or the network device (e.g., network device 705) performs operations associated with frequency hopping for A-IoT R2D repetitions.

As shown in FIG. 10, in some aspects, process 1000 may include receiving, from an A-IoT reader device, capability information that indicates a frequency hopping capability of the A-IoT reader device (block 1010). For example, the network device (e.g., using communication manager 1705 and/or reception component 1702, depicted in FIG. 17) may receive, from an A-IoT reader device, capability information that indicates a frequency hopping capability of the A-IoT reader device, as described above.

As further shown in FIG. 10, in some aspects, process 1000 may include transmitting, to the A-IoT reader device, configuration information that indicates a frequency hopping pattern for an R2D signal and one or more repetitions of a data block of the R2D signal (block 1020). For example, the network device (e.g., using communication manager 1705 and/or transmission component 1704, depicted in FIG. 17) may transmit, to the A-IoT reader device, configuration information that indicates a frequency hopping pattern for an R2D signal and one or more repetitions of a data block of the R2D signal, as described above.

Process 1000 may include additional aspects, such as any single aspect or any combination of aspects described below and/or in connection with one or more other processes described elsewhere herein.

In a first aspect, transmitting the configuration information includes transmitting the configuration information via RRC signaling.

In a second aspect, alone or in combination with the first aspect, the configuration information configures each repetition, of the one or more repetitions, to include one or more automatic gain control symbols and the data block of the R2D signal.

In a third aspect, alone or in combination with one or more of the first and second aspects, the configuration information indicates time resources for transmission of the R2D signal and the one or more repetitions of the R2D signal.

In a fourth aspect, alone or in combination with one or more of the first through third aspects, the time resources indicate a time gap preceding each repetition of the one or more repetitions.

In a fifth aspect, alone or in combination with one or more of the first through fourth aspects, the time resources are based at least in part on the capability information.

In a sixth aspect, alone or in combination with one or more of the first through fifth aspects, the configuration information indicates a quantity of the one or more repetitions.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be an A-IoT reader device, or an A-IoT reader device may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a network node, or another wireless communication device) using the reception component 1102 and the transmission component 1104. As further shown, the apparatus 1100 may include a communication manager 1105 (for example, the communication manager 155 or the communication manager 150 described in connection with FIG. 1). The communication manager 1105 may include a determination component 1108, among other examples. The communication manager 1105 may be included in, or implemented via, a processing system (for example, the processing system 145 or the processing system 140 described in connection with FIG. 1) of the A-IoT reader device.

In some aspects, the apparatus 1100 may be configured to perform one or more operations described herein in connection with FIGS. 3-6 and 7A-7D. Additionally, or alternatively, the apparatus 1100 may be configured to perform one or more processes described herein, such as process 800 of FIG. 8, or a combination thereof. In some aspects, the apparatus 1100 and/or one or more components shown in FIG. 11 may include one or more components of the network node 110 or the UE 120 described in connection with FIG. 1. Additionally, or alternatively, one or more components shown in FIG. 11 may be implemented within one or more components described in connection with FIG. 1. Additionally, or alternatively, one or more components shown in FIG. 11 may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the network node 110 or the UE 120 described above in connection with FIG. 1, such as a radio, one or more RF chains, one or more transceivers, or one or more modems, each of which may in turn be coupled with one or more antennas of the network node 110 or the UE 120 described in connection with FIG. 1.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more components of the network node 110 or the UE 120 described above in connection with FIG. 1, such as a radio, one or more RF chains, one or more transceivers, or one or more modems, each of which may in turn be coupled with one or more antennas of the network node 110 or the UE 120 described in connection with FIG. 1. In some aspects, the transmission component 1104 may be co-located with the reception component 1102.

The reception component 1102 may receive configuration information that indicates a frequency hopping pattern for an R2D signal. The transmission component 1104 may transmit the R2D signal and one or more repetitions of a data block of the R2D signal on different carrier frequencies in accordance with the frequency hopping pattern.

The determination component 1108 may determine a respective carrier frequency for the R2D signal and each repetition of the one or more repetitions in accordance with the frequency hopping pattern.

The transmission component 1104 may transmit capability information that indicates a frequency hopping capability of the A-IoT reader device.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

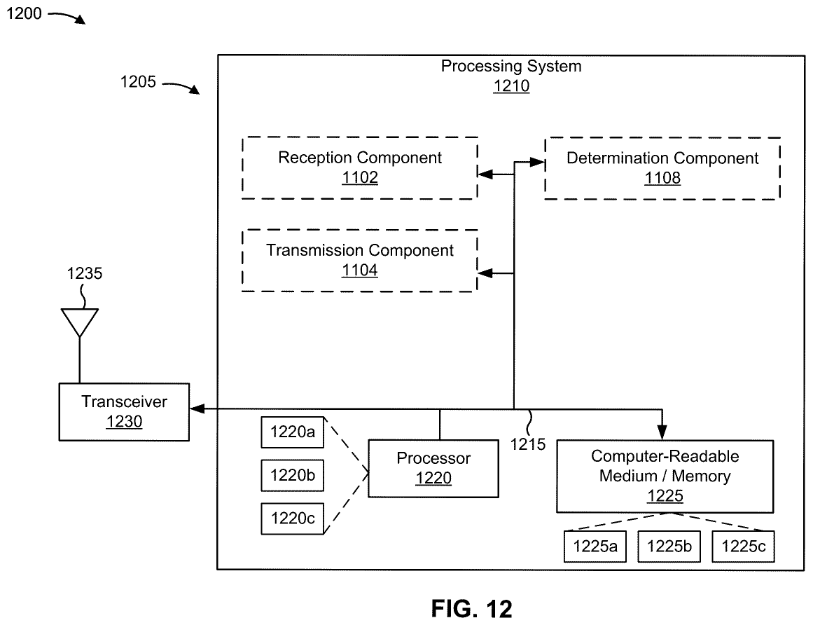

FIG. 12 is a diagram illustrating an example 1200 of a hardware implementation for an apparatus 1205 employing a processing system 1210, in accordance with the present disclosure. The apparatus 1205 may be an A-IoT reader device or may be at (e.g., included in) an A-IoT reader device.

The processing system 1210 may be implemented with a bus architecture, represented generally by the bus 1215. The bus 1215 may include any number of interconnecting buses and bridges depending on the specific application of the processing system 1210 and the overall design constraints. The bus 1215 links together various circuits including one or more processors and/or hardware components, represented by the processor (or processing circuitry) 1220, the illustrated components, and the computer-readable medium/memory (or memory circuitry) 1225. The processor 1220 may include multiple processors, such as processor 1220a, processor 1220b, and processor 1220c. The memory 1225 may include multiple memories, such as memory 1225a, memory 1225b, and memory 1225c. The bus 1215 may also link various other circuits, such as timing sources, peripherals, voltage regulators, and/or power management circuits.

The processing system 1210 may be coupled to one or more transceivers 1230. A transceiver 1230 is coupled to one or more antennas 1235. The transceiver 1230 provides a means for communicating with various other apparatuses over a transmission medium. The transceiver 1230 receives a signal from the one or more antennas 1235, extracts information from the received signal, and provides the extracted information to the processing system 1210, specifically the reception component 1102. In addition, the transceiver 1230 receives information from the processing system 1210, specifically the transmission component 1104, and generates a signal to be applied to the one or more antennas 1235 based at least in part on the received information.

The processing system 1210 includes one or more processors 1220 coupled to a computer-readable medium/memory 1225. A processor 1220 is responsible for general processing, including the execution of software stored on the computer-readable medium/memory 1225. The software, when executed by the processor 1220, causes the processing system 1210 to perform the various functions described herein for any particular apparatus. The computer-readable medium/memory 1225 may also be used for storing data that is manipulated by the processor 1220 when executing software. The processing system further includes at least one of the illustrated components. The components may be software modules running in the processor 1220, resident/stored in the computer readable medium/memory 1225, one or more hardware modules coupled to the processor 1220, or some combination thereof.

In some aspects, the processing system 1210 may be, may include, or may be included in the processing system 145 of the network node 110 described in connection with FIG. 1. In some aspects, the processing system 1210 may be, may include, or may be included in the processing system 140 of the UE 120 described in connection with FIG. 1. In some aspects, the apparatus 1205 for wireless communication includes means for receiving configuration information that indicates a frequency hopping pattern for an R2D signal; and means for transmitting the R2D signal and one or more repetitions of a data block of the R2D signal on different carrier frequencies in accordance with the frequency hopping pattern. The aforementioned means may be one or more of the aforementioned components of the apparatus 1100 and/or the processing system 1210 of the apparatus 1205 configured to perform the functions recited by the aforementioned means. As described elsewhere herein, the processing system 1210 may include the processing system 145 or the processing system 140 described in connection with FIG. 1. In one configuration, the aforementioned means may be the processing system 145 and/or one or more components of the processing system 145 described in connection with FIG. 1 configured to perform the functions and/or operations recited herein. In one configuration, the aforementioned means may be the processing system 140 and/or one or more components of the processing system 140 described in connection with FIG. 1 configured to perform the functions and/or operations recited herein.

FIG. 12 is provided as an example. Other examples may differ from what is described in connection with FIG. 12.

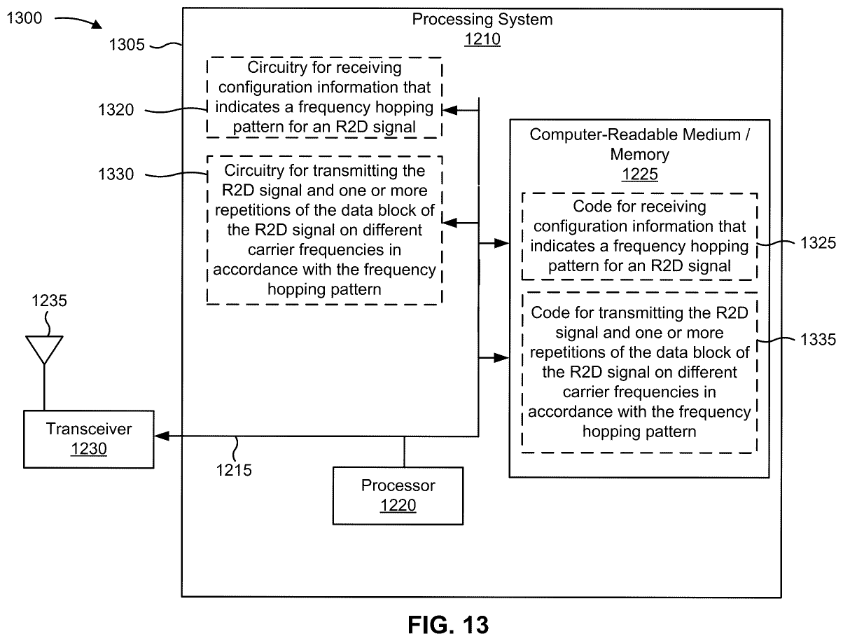

FIG. 13 is a diagram illustrating an example 1300 of an implementation of code and circuitry for an apparatus 1305, in accordance with the present disclosure. The apparatus 1305 may be an A-IoT reader device, or an A-IoT reader device may include the apparatus 1305.

As shown in FIG. 13, the apparatus 1305 may include circuitry for receiving configuration information that indicates a frequency hopping pattern for an R2D signal (circuitry 1320). For example, the circuitry 1320 may enable the apparatus 1305 to receive configuration information that indicates a frequency hopping pattern for an R2D signal.

As shown in FIG. 13, the apparatus 1305 may include, stored in computer-readable medium 1225, code for receiving configuration information that indicates a frequency hopping pattern for an R2D signal (code 1325). For example, the code 1325, when executed by processor 1220, may cause processor 1220 to cause transceiver 1230 to receive configuration information that indicates a frequency hopping pattern for an R2D signal.

As shown in FIG. 13, the apparatus 1305 may include circuitry for transmitting the R2D signal and one or more repetitions of a data block of the R2D signal on different carrier frequencies in accordance with the frequency hopping pattern (circuitry 1330). For example, the circuitry 1330 may enable the apparatus 1305 to transmit the R2D signal and one or more repetitions of a data block of the R2D signal on different carrier frequencies in accordance with the frequency hopping pattern.

As shown in FIG. 13, the apparatus 1305 may include, stored in computer-readable medium 1225, code for transmitting the R2D signal and one or more repetitions of a data block of the R2D signal on different carrier frequencies in accordance with the frequency hopping pattern (code 1335). For example, the code 1335, when executed by processor 1220, may cause processor 1220 to cause transceiver 1230 to transmit the R2D signal and one or more repetitions of a data block of the R2D signal on different carrier frequencies in accordance with the frequency hopping pattern.

FIG. 13 is provided as an example. Other examples may differ from what is described in connection with FIG. 13.

FIG. 14 is a diagram of an example apparatus 1400 for wireless communication, in accordance with the present disclosure. The apparatus 1400 may be an A-IoT device, or an A-IoT device may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include a communication manager 1405 (for example, the communication manager 150 described in connection with FIG. 1). The communication manager 1405 may include a decoding component 1408 and/or a tuning component 1410, among other examples. The communication manager 1405 may be included in, or implemented via, a processing system (for example, the processing system 140 described in connection with FIG. 1) of the A-IoT device

In some aspects, the apparatus 1400 may be configured to perform one or more operations described herein in connection with FIGS. 3-6 and 7A-7D. Additionally, or alternatively, the apparatus 1400 may be configured to perform one or more processes described herein, such as process 900 of FIG. 9, or a combination thereof. In some aspects, the apparatus 1400 and/or one or more components shown in FIG. 14 may include one or more components of the UE 120 described in connection with FIG. 1. Additionally, or alternatively, one or more components shown in FIG. 14 may be implemented within one or more components described in connection with FIG. 1. Additionally, or alternatively, one or more components shown in FIG. 14 may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications, and may provide the processed signals to the one or more other components of the apparatus 1400. In some aspects, the reception component 1402 may include one or more components of the UE 120 described above in connection with FIG. 1, such as a radio, one or more RF chains, one or more transceivers, or one or more modems, each of which may in turn be coupled with one or more antennas of the UE 120 described in connection with FIG. 1.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more components of the UE 120 described above in connection with FIG. 1, such as a radio, one or more RF chains, one or more transceivers, or one or more modems, each of which may in turn be coupled with one or more antennas of the UE 120 described in connection with FIG. 1. In some aspects, the transmission component 1404 may be co-located with the reception component 1402.

The reception component 1402 may receive, from an A-IoT reader device, an R2D signal and one or more repetitions of a data block of the R2D signal on different carrier frequencies. The decoding component 1408 may decode the data block of the R2D signal based on at least one of the R2D signal or the one or more repetitions.

The tuning component 1410 may tune a comparator threshold based at least in part on the one or more automatic gain control symbols included in each repetition of the one or more repetitions.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

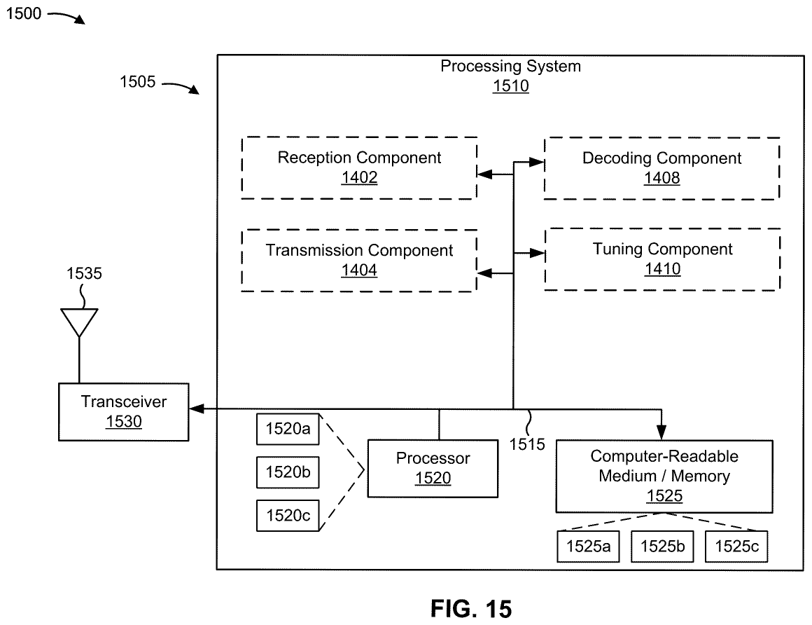

FIG. 15 is a diagram illustrating an example 1500 of a hardware implementation for an apparatus 1505 employing a processing system 1510, in accordance with the present disclosure. The apparatus 1505 may be an A-IoT device or may be at (e.g., included in) an A-IoT device.

The processing system 1510 may be implemented with a bus architecture, represented generally by the bus 1515. The bus 1515 may include any number of interconnecting buses and bridges depending on the specific application of the processing system 1510 and the overall design constraints. The bus 1515 links together various circuits including one or more processors and/or hardware components, represented by the processor (or processing circuitry) 1520, the illustrated components, and the computer-readable medium/memory (or memory circuitry) 1525. The processor 1520 may include multiple processors, such as processor 1520a, processor 1520b, and processor 1520c. The memory 1525 may include multiple memories, such as memory 1525a, memory 1525b, and memory 1525c. The bus 1515 may also link various other circuits, such as timing sources, peripherals, voltage regulators, and/or power management circuits.

The processing system 1510 may be coupled to one or more transceivers 1530. A transceiver 1530 is coupled to one or more antennas 1535. The transceiver 1530 provides a means for communicating with various other apparatuses over a transmission medium. The transceiver 1530 receives a signal from the one or more antennas 1535, extracts information from the received signal, and provides the extracted information to the processing system 1510, specifically the reception component 1402. In addition, the transceiver 1530 receives information from the processing system 1510, specifically the transmission component 1404, and generates a signal to be applied to the one or more antennas 1535 based at least in part on the received information.

The processing system 1510 includes one or more processors 1520 coupled to a computer-readable medium/memory 1525. A processor 1520 is responsible for general processing, including the execution of software stored on the computer-readable medium/memory 1525. The software, when executed by the processor 1520, causes the processing system 1510 to perform the various functions described herein for any particular apparatus. The computer-readable medium/memory 1525 may also be used for storing data that is manipulated by the processor 1520 when executing software. The processing system further includes at least one of the illustrated components. The components may be software modules running in the processor 1520, resident/stored in the computer readable medium/memory 1525, one or more hardware modules coupled to the processor 1520, or some combination thereof.

In some aspects, the processing system 1510 may be, may include, or may be included in the processing system 140 of the UE 120 described in connection with FIG. 1. In some aspects, the apparatus 1505 for wireless communication includes means for receiving, from an A-IoT reader device, an R2D signal and one or more repetitions of a data block of the R2D signal on different carrier frequencies; and means for decoding the data block of the R2D signal based on at least one of the R2D signal or the one or more repetitions. The aforementioned means may be one or more of the aforementioned components of the apparatus 1400 and/or the processing system 1510 of the apparatus 1505 configured to perform the functions recited by the aforementioned means. As described elsewhere herein, the processing system 1510 may include the processing system 140 described in connection with FIG. 1. In one configuration, the aforementioned means may be the processing system 140 and/or one or more components of the processing system 140 described in connection with FIG. 1 configured to perform the functions and/or operations recited herein.

FIG. 15 is provided as an example. Other examples may differ from what is described in connection with FIG. 15.

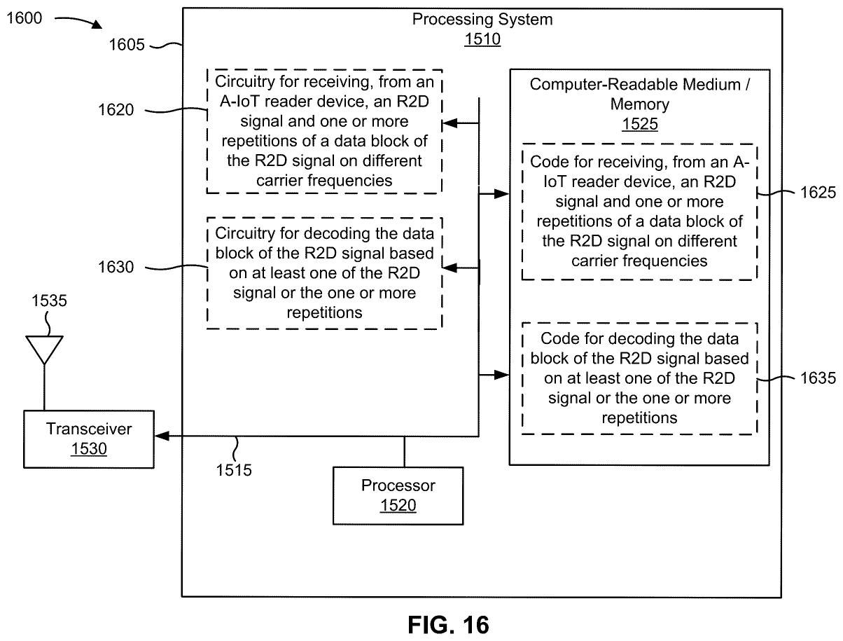

FIG. 16 is a diagram illustrating an example 1600 of an implementation of code and circuitry for an apparatus 1605, in accordance with the present disclosure. The apparatus 1605 may be an A-IoT device, or an A-IoT device may include the apparatus 1605.

As shown in FIG. 16, the apparatus 1605 may include circuitry for receiving, from an A-IoT reader device, an R2D signal and one or more repetitions of a data block of the R2D signal on different carrier frequencies (circuitry 1620). For example, the circuitry 1620 may enable the apparatus 1605 to receive, from an A-IoT reader device, an R2D signal and one or more repetitions of a data block of the R2D signal on different carrier frequencies.

As shown in FIG. 16, the apparatus 1605 may include, stored in computer-readable medium 1525, code for receiving, from an A-IoT reader device, an R2D signal and one or more repetitions of a data block of the R2D signal on different carrier frequencies (code 1625). For example, the code 1625, when executed by processor 1520, may cause processor 1520 to cause transceiver 1530 to receive, from an A-IoT reader device, an R2D signal and one or more repetitions of a data block of the R2D signal on different carrier frequencies.

As shown in FIG. 16, the apparatus 1605 may include circuitry for decoding the data block of the R2D signal based on at least one of the R2D signal or the one or more repetitions (circuitry 1630). For example, the circuitry 1630 may enable the apparatus 1605 to decode the data block of the R2D signal based on at least one of the R2D signal or the one or more repetitions.

As shown in FIG. 16, the apparatus 1605 may include, stored in computer-readable medium 1525, code for decoding the data block of the R2D signal based on at least one of the R2D signal or the one or more repetitions (code 1635). For example, the code 1635, when executed by processor 1520, may cause processor 1520 to decode the data block of the R2D signal based on at least one of the R2D signal or the one or more repetitions.

FIG. 16 is provided as an example. Other examples may differ from what is described in connection with FIG. 16.

FIG. 17 is a diagram of an example apparatus 1700 for wireless communication, in accordance with the present disclosure. The apparatus 1700 may be a network device, or a network device may include the apparatus 1700. In some aspects, the apparatus 1700 includes a reception component 1702 and a transmission component 1704, which may be in communication with one another (for example, via one or more buses and/or one or more other components). As shown, the apparatus 1700 may communicate with another apparatus 1706 (such as a UE, a base station, or another wireless communication device) using the reception component 1702 and the transmission component 1704. As further shown, the apparatus 1700 may include a communication manager 1705 (for example, the communication manager 155 or the communication manager 150 described in connection with FIG. 1). The communication manager 1705 may include a determination component 1708, among other examples. The communication manager 1705 may be included in, or implemented via, a processing system (for example, the processing system 145 or the processing system 140 described in connection with FIG. 1) of the network device.

In some aspects, the apparatus 1700 may be configured to perform one or more operations described herein in connection with FIGS. 3-6 and 7A-7D. Additionally, or alternatively, the apparatus 1700 may be configured to perform one or more processes described herein, such as process 1000 of FIG. 10, or a combination thereof. In some aspects, the apparatus 1700 and/or one or more components shown in FIG. 17 may include one or more components of the network node 110 or the UE 120 described in connection with FIG. 1. Additionally, or alternatively, one or more components shown in FIG. 17 may be implemented within one or more components described in connection with FIG. 1. Additionally, or alternatively, one or more components shown in FIG. 17 may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1702 may receive communications, such as reference signals, control information, data communications, or a combination thereof, from the apparatus 1706. The reception component 1702 may provide received communications to one or more other components of the apparatus 1700. In some aspects, the reception component 1702 may perform signal processing on the received communications, and may provide the processed signals to the one or more other components of the apparatus 1700. In some aspects, the reception component 1702 may include one or more components of the network node 110 or the UE 120 described above in connection with FIG. 1, such as a radio, one or more RF chains, one or more transceivers, or one or more modems, each of which may in turn be coupled with one or more antennas of the network node 110 or the UE 120 described in connection with FIG. 1.

The transmission component 1704 may transmit communications, such as reference signals, control information, data communications, or a combination thereof, to the apparatus 1706. In some aspects, one or more other components of the apparatus 1700 may generate communications and may provide the generated communications to the transmission component 1704 for transmission to the apparatus 1706. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1706. In some aspects, the transmission component 1704 may include one or more components of the network node 110 or the UE 120 described above in connection with FIG. 1, such as a radio, one or more RF chains, one or more transceivers, or one or more modems, each of which may in turn be coupled with one or more antennas of the network node 110 or the UE 120 described in connection with FIG. 1. In some aspects, the transmission component 1704 may be co-located with the reception component 1702.

The reception component 1702 may receive, from an A-IoT reader device, capability information that indicates a frequency hopping capability of the A-IoT reader device. The transmission component 1704 may transmit, to the A-IoT reader device, configuration information that indicates a frequency hopping pattern for an R2D signal and one or more repetitions of a data block of the R2D signal.

The determination component 1708 may determine the frequency hopping pattern for the R2D signal and the one or more repetitions of the data block of the R2D signal.

The number and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

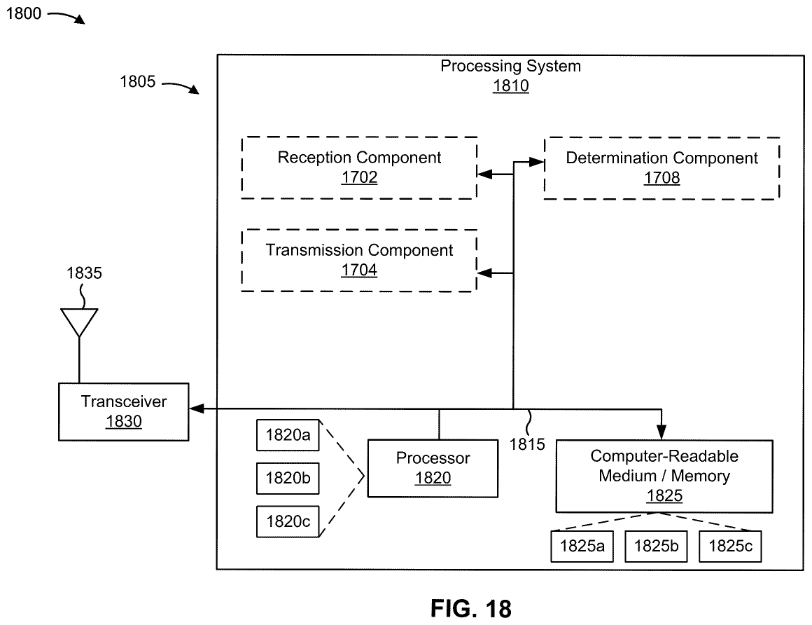

FIG. 18 is a diagram illustrating an example 1800 of a hardware implementation for an apparatus 1805 employing a processing system 1810, in accordance with the present disclosure. The apparatus 1805 may be a network device or may be at (e.g., included in) a network device.

The processing system 1810 may be implemented with a bus architecture, represented generally by the bus 1815. The bus 1815 may include any number of interconnecting buses and bridges depending on the specific application of the processing system 1810 and the overall design constraints. The bus 1815 links together various circuits including one or more processors and/or hardware components, represented by the processor (or processing circuitry) 1820, the illustrated components, and the computer-readable medium/memory (or memory circuitry) 1825. The processor 1820 may include multiple processors, such as processor 1820a, processor 1820b, and processor 1820c. The memory 1825 may include multiple memories, such as memory 1825a, memory 1825b, and memory 1825c. The bus 1815 may also link various other circuits, such as timing sources, peripherals, voltage regulators, and/or power management circuits.

The processing system 1810 may be coupled to one or more transceivers 1830. A transceiver 1830 is coupled to one or more antennas 1835. The transceiver 1830 provides a means for communicating with various other apparatuses over a transmission medium. The transceiver 1830 receives a signal from the one or more antennas 1835, extracts information from the received signal, and provides the extracted information to the processing system 1810, specifically the reception component 1702. In addition, the transceiver 1830 receives information from the processing system 1810, specifically the transmission component 1704, and generates a signal to be applied to the one or more antennas 1835 based at least in part on the received information.

The processing system 1810 includes one or more processors 1820 coupled to a computer-readable medium/memory 1825. A processor 1820 is responsible for general processing, including the execution of software stored on the computer-readable medium/memory 1825. The software, when executed by the processor 1820, causes the processing system 1810 to perform the various functions described herein for any particular apparatus. The computer-readable medium/memory 1825 may also be used for storing data that is manipulated by the processor 1820 when executing software. The processing system further includes at least one of the illustrated components. The components may be software modules running in the processor 1820, resident/stored in the computer readable medium/memory 1825, one or more hardware modules coupled to the processor 1820, or some combination thereof.

In some aspects, the processing system 1810 may be, may include, or may be included in the processing system 145 of the network node 110 described in connection with FIG. 1. In some aspects, the processing system 1810 may be, may include, or may be included in the processing system 140 of the UE 120 described in connection with FIG. 1. In some aspects, the apparatus 1805 for wireless communication includes means for receiving, from an A-IoT reader device, capability information that indicates a frequency hopping capability of the A-IoT reader device; and means for transmitting, to the A-IoT reader device, configuration information that indicates a frequency hopping pattern for an R2D signal and one or more repetitions of a data block of the R2D signal. The aforementioned means may be one or more of the aforementioned components of the apparatus 1700 and/or the processing system 1810 of the apparatus 1805 configured to perform the functions recited by the aforementioned means. As described elsewhere herein, the processing system 1810 may include the processing system 145 or the processing system 140 described in connection with FIG. 1. In one configuration, the aforementioned means may be the processing system 145 and/or one or more components of the processing system 145 described in connection with FIG. 1 configured to perform the functions and/or operations recited herein. In one configuration, the aforementioned means may be the processing system 140 and/or one or more components of the processing system 140 described in connection with FIG. 1 configured to perform the functions and/or operations recited herein.

FIG. 18 is provided as an example. Other examples may differ from what is described in connection with FIG. 18.

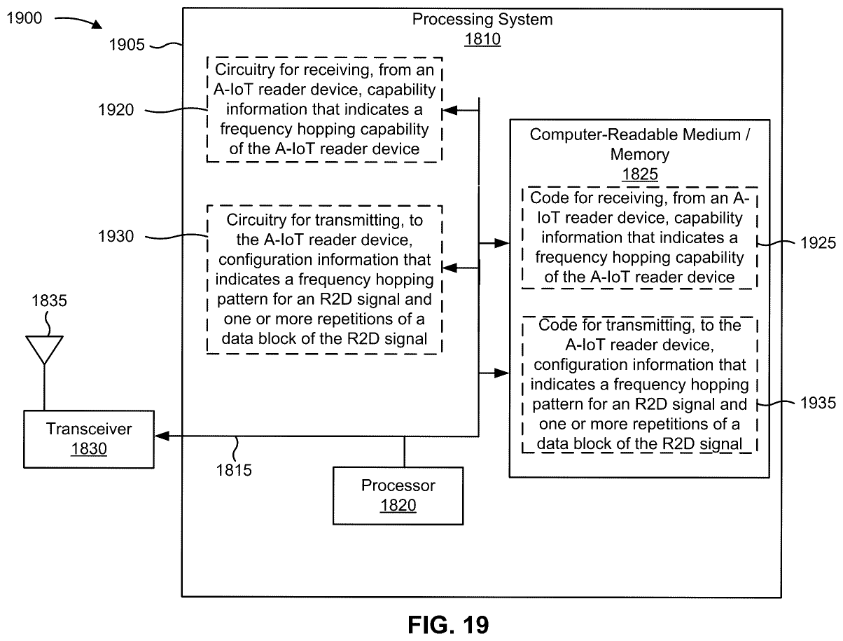

FIG. 19 is a diagram illustrating an example 1900 of an implementation of code and circuitry for an apparatus 1905, in accordance with the present disclosure. The apparatus 1905 may be a network device, or a network device may include the apparatus 1905.

As shown in FIG. 19, the apparatus 1905 may include circuitry for receiving, from an A-IoT reader device, capability information that indicates a frequency hopping capability of the A-IoT reader device (circuitry 1920). For example, the circuitry 1920 may enable the apparatus 1905 to receive, from an A-IoT reader device, capability information that indicates a frequency hopping capability of the A-IoT reader device.

As shown in FIG. 19, the apparatus 1905 may include, stored in computer-readable medium 1825, code for receiving, from an A-IoT reader device, capability information that indicates a frequency hopping capability of the A-IoT reader device (code 1925). For example, the code 1925, when executed by processor 1820, may cause processor 1820 to cause transceiver 1830 to receive, from an A-IoT reader device, capability information that indicates a frequency hopping capability of the A-IoT reader device.

As shown in FIG. 19, the apparatus 1905 may include circuitry for transmitting, to the A-IoT reader device, configuration information that indicates a frequency hopping pattern for an R2D signal and one or more repetitions of a data block of the R2D signal (circuitry 1930). For example, the circuitry 1930 may enable the apparatus 1905 to transmit, to the A-IoT reader device, configuration information that indicates a frequency hopping pattern for an R2D signal and one or more repetitions of a data block of the R2D signal.

As shown in FIG. 19, the apparatus 1905 may include, stored in computer-readable medium 1825, code for transmitting, to the A-IoT reader device, configuration information that indicates a frequency hopping pattern for an R2D signal and one or more repetitions of a data block of the R2D signal (code 1935). For example, the code 1935, when executed by processor 1820, may cause processor 1820 to cause transceiver 1830 to transmit, to the A-IoT reader device, configuration information that indicates a frequency hopping pattern for an R2D signal and one or more repetitions of a data block of the R2D signal.

FIG. 19 is provided as an example. Other examples may differ from what is described in connection with FIG. 19.

The following provides an overview of some Aspects of the present disclosure:

Aspect 1: A method of wireless communication at an ambient internet of things (A-IoT) reader device, comprising: receiving configuration information that indicates a frequency hopping pattern for a reader-to-device (R2D) signal; and transmitting the R2D signal and one or more repetitions of a data block of the R2D signal on different carrier frequencies in accordance with the frequency hopping pattern.

Aspect 2: The method of Aspect 1, wherein receiving the configuration information comprises: receiving the configuration information via radio resource control (RRC) signaling.

Aspect 3: The method of any of Aspects 1-2, wherein the R2D signal includes a start indicator part (SIP), a clock acquisition part (CAP), control information, and the data block.

Aspect 4: The method of any of Aspects 1-3, wherein each repetition, of the one or more repetitions, includes one or more automatic gain control symbols and the data block of the R2D signal.

Aspect 5: The method of any of Aspects 1-4, wherein the configuration information indicates time resources for transmission of the R2D signal and the one or more repetitions of the R2D signal.

Aspect 6: The method of Aspect 5, wherein the time resources indicate a time gap preceding each repetition of the one or more repetitions.

Aspect 7: The method of any of Aspects 5-6, further comprising: transmitting capability information that indicates a frequency hopping capability of the A-IoT reader device, wherein the time resources are based at least in part on the capability information.

Aspect 8: The method of any of Aspects 1-7, wherein the configuration information indicates a quantity of the one or more repetitions.

Aspect 9: A method of wireless communication performed at an ambient internet of things (A-IoT) device, comprising: receiving, from an A-IoT reader device, a reader-to-device (R2D) signal and one or more repetitions of a data block of the R2D signal on different carrier frequencies; and decoding the data block of the R2D signal based on at least one of the R2D signal or the one or more repetitions.

Aspect 10: The method of Aspect 9, wherein the R2D signal includes a start indicator part (SIP), a clock acquisition part (CAP), control information, and the data block.

Aspect 11: The method of any of Aspects 9-10, wherein each repetition, of the one or more repetitions, includes one or more automatic gain control symbols and the data block of the R2D signal.

Aspect 12: The method of Aspect 11, further comprising: tuning a comparator threshold based at least in part on the one or more automatic gain control symbols included in each repetition of the one or more repetitions.

Aspect 13: The method of any of Aspects 9-12, wherein consecutive repetitions, of the one or more repetitions, are separated by a time gap.

Aspect 14: A method of wireless communication at a network device, comprising: receiving, from an ambient internet of things (A-IoT) reader device, capability information that indicates a frequency hopping capability of the A-IoT reader device; and transmitting, to the A-IoT reader device, configuration information that indicates a frequency hopping pattern for a reader-to-device (R2D) signal and one or more repetitions of a data block of the R2D signal.

Aspect 15: The method of Aspect 14, wherein transmitting the configuration information comprises: transmitting the configuration information via radio resource control (RRC) signaling.

Aspect 16: The method of any of Aspects 14-15, wherein the configuration information configures each repetition, of the one or more repetitions, to include one or more automatic gain control symbols and the data block of the R2D signal.

Aspect 17: The method of any of Aspects 14-16, wherein the configuration information indicates time resources for transmission of the R2D signal and the one or more repetitions of the R2D signal.

Aspect 18: The method of Aspect 17, wherein the time resources indicate a time gap preceding each repetition of the one or more repetitions.

Aspect 19: The method of any of Aspects 17-18, wherein the time resources are based at least in part on the capability information.

Aspect 20: The method of any of Aspects 14-19, wherein the configuration information indicates a quantity of the one or more repetitions.

Aspect 21: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-20.

Aspect 22: An apparatus for wireless communication at a device, the apparatus comprising one or more memories and one or more processors coupled to the one or more memories, the one or more processors configured to cause the device to perform the method of one or more of Aspects 1-20.

Aspect 23: An apparatus for wireless communication, the apparatus comprising at least one means for performing the method of one or more of Aspects 1-20.

Aspect 24: A non-transitory computer-readable medium storing code for wireless communication, the code comprising instructions executable by one or more processors to perform the method of one or more of Aspects 1-20.

Aspect 25: A non-transitory computer-readable medium storing a set of instructions for wireless communication, the set of instructions comprising one or more instructions that, when executed by one or more processors of a device, cause the device to perform the method of one or more of Aspects 1-20.

Aspect 26: A device for wireless communication, the device comprising a processing system that includes one or more processors and one or more memories coupled with the one or more processors, the processing system configured to cause the device to perform the method of one or more of Aspects 1-20.

Aspect 27: An apparatus for wireless communication at a device, the apparatus comprising one or more memories and one or more processors coupled to the one or more memories, the one or more processors individually or collectively configured to cause the device to perform the method of one or more of Aspects 1-20.

Aspect 28: An apparatus for wireless communication at a device, comprising: a processing system that includes processor circuitry and memory circuitry that stores code and is coupled with the processor circuitry, the processing system configured to cause the device to perform the method of one or more of Aspects 1-20.

Aspect 29: An apparatus for wireless communication at an ambient internet of things (A-IoT) reader device, comprising: one or more memories; and one or more processors coupled to the one or more memories, the one or more processors configured to cause the A-IoT reader device to: receive configuration information that indicates a frequency hopping pattern for a reader-to-device (R2D) signal; and transmit the R2D signal and one or more repetitions of a data block of the R2D signal on different carrier frequencies in accordance with the frequency hopping pattern.

Aspect 30: The apparatus of Aspect 29, wherein the one or more processors are configured, individually or collectively, to cause the A-IoT reader device to: receive configuration information that indicates a frequency hopping pattern for a reader-to-device (R2D) signal; and transmit the R2D signal and one or more repetitions of a data block of the R2D signal on different carrier frequencies in accordance with the frequency hopping pattern.

Aspect 31: An apparatus for wireless communication at an ambient internet of things (A-IoT) device, comprising: one or more memories; and one or more processors coupled to the one or more memories, the one or more processors configured to cause the A-IoT device to: receive, from an A-IoT reader device, a reader-to-device (R2D) signal and one or more repetitions of a data block of the R2D signal on different carrier frequencies; and decode the data block of the R2D signal based on at least one of the R2D signal or the one or more repetitions.

Aspect 32: The apparatus of Aspect 31, wherein the one or more processors are configured, individually or collectively, to cause the A-IoT device to: receive, from an A-IoT reader device, a reader-to-device (R2D) signal and one or more repetitions of a data block of the R2D signal on different carrier frequencies; and decode the data block of the R2D signal based on at least one of the R2D signal or the one or more repetitions.

Aspect 33: An apparatus for wireless communication at a network device, comprising: one or more memories; and one or more processors coupled to the one or more memories, the one or more processors configured to cause the network device to: receive, from an ambient internet of things (A-IoT) reader device, capability information that indicates a frequency hopping capability of the A-IoT reader device; and transmit, to the A-IoT reader device, configuration information that indicates a frequency hopping pattern for a reader-to-device (R2D) signal and one or more repetitions of a data block of the R2D signal.

Aspect 34: The apparatus of Aspect 33, wherein the one or more processors are configured, individually or collectively, to cause the network device to: receive, from an ambient internet of things (A-IoT) reader device, capability information that indicates a frequency hopping capability of the A-IoT reader device; and transmit, to the A-IoT reader device, configuration information that indicates a frequency hopping pattern for a reader-to-device (R2D) signal and one or more repetitions of a data block of the R2D signal.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “associated with” encompasses any association, connection link, or relation and, therefore, “associated with” may include in associated with, based on, based at least in part on, corresponding to, related to, linked with, connected with, or in response to, among other possibilities. As used herein, “using” may include any use, consideration, calculation, or dependency, among other possibilities. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at an ambient internet of things (A-IoT) reader device, comprising:
one or more memories; and
one or more processors coupled with the one or more memories and configured to cause the A-IoT reader device to:
receive configuration information that indicates a frequency hopping pattern for a reader-to-device (R2D) signal; and
transmit the R2D signal and one or more repetitions of a data block of the R2D signal on different carrier frequencies in accordance with the frequency hopping pattern.

2. The apparatus of claim 1, wherein the one or more processors, to cause the A-IoT reader device to receive the configuration information, are configured to cause the A-IoT reader device to:
receive the configuration information via radio resource control (RRC) signaling.

3. The apparatus of claim 1, wherein the R2D signal includes a start indicator part (SIP), a clock acquisition part (CAP), control information, and the data block.

4. The apparatus of claim 1, wherein each repetition, of the one or more repetitions, includes one or more automatic gain control symbols and the data block of the R2D signal.

5. The apparatus of claim 1, wherein the configuration information indicates time resources for transmission of the R2D signal and the one or more repetitions of the R2D signal.

6. The apparatus of claim 5, wherein the time resources indicate a time gap preceding each repetition of the one or more repetitions.

7. The apparatus of claim 5, wherein the one or more processors are configured to cause the A-IoT reader device to:
transmit capability information that indicates a frequency hopping capability of the A-IoT reader device, wherein the time resources are based at least in part on the capability information.

8. The apparatus of claim 1, wherein the configuration information indicates a quantity of the one or more repetitions.

9. An apparatus for wireless communication at an ambient internet of things (A-IoT) device, comprising:
one or more memories; and
one or more processors coupled with the one or more memories and configured to cause the A-IoT device to:
receive, from an A-IoT reader device, a reader-to-device (R2D) signal and one or more repetitions of a data block of the R2D signal on different carrier frequencies; and
decode the data block of the R2D signal based on at least one of the R2D signal or the one or more repetitions.

10. The apparatus of claim 9, wherein the R2D signal includes a start indicator part (SIP), a clock acquisition part (CAP), control information, and the data block.

11. The apparatus of claim 9, wherein each repetition, of the one or more repetitions, includes one or more automatic gain control symbols and the data block of the R2D signal.

12. The apparatus of claim 11, wherein the one or more processors are configured to cause the A-IoT device to:
tune a comparator threshold based at least in part on the one or more automatic gain control symbols included in each repetition of the one or more repetitions.

13. The apparatus of claim 9, wherein consecutive repetitions, of the one or more repetitions, are separated by a time gap.

14. An apparatus for wireless communication at a network device, comprising:
one or more memories; and
one or more processors coupled with the one or more memories and configured to cause the network device to:
receive, from an ambient internet of things (A-IoT) reader device, capability information that indicates a frequency hopping capability of the A-IoT reader device; and
transmit, to the A-IoT reader device, configuration information that indicates a frequency hopping pattern for a reader-to-device (R2D) signal and one or more repetitions of a data block of the R2D signal.

15. The apparatus of claim 14, wherein the one or more processors, to cause the network device to transmit the configuration information, are configured to cause the network device to:
transmit the configuration information via radio resource control (RRC) signaling.

16. The apparatus of claim 14, wherein the configuration information configures each repetition, of the one or more repetitions, to include one or more automatic gain control symbols and the data block of the R2D signal.

17. The apparatus of claim 14, wherein the configuration information indicates time resources for transmission of the R2D signal and the one or more repetitions of the R2D signal.

18. The apparatus of claim 17, wherein the time resources indicate a time gap preceding each repetition of the one or more repetitions.

19. The apparatus of claim 17, wherein the time resources are based at least in part on the capability information.

20. The apparatus of claim 14, wherein the configuration information indicates a quantity of the one or more repetitions.
